(19) United States
(12) Patent Application Publication
(10) Pub. No.: US 2026/0036138 A1
(43) Pub. Date: Feb. 5, 2026

(54) TURBINE HOUSINGS FOR A TURBOCHARGER, TURBINE AND TURBOCHARGER

(71) Applicant: Cummins Ltd, London (GB)

(72) Inventor: Christopher Gentle, London (GB)

(21) Appl. No.: 18/997,419

(22) PCT Filed: Jul. 20, 2023
(86) PCT No.: PCT/GB2023/051916

§ 371 Date: Jan. 21, 2025

(30) Foreign Application Priority Data
Jul. 21, 2022 (GB) 2210653.8

(51) Int. Cl. F04D 29/42; F02B 37/00; F04D 17/10

(52) U.S. Cl. CPC F04D 29/4206; F04D 17/10; F02B 37/00

(57) ABSTRACT

There is disclosed a turbine housing for a turbocharger. The turbine housing comprises a flange and a volute. The flange has an engagement surface and a first inlet opening in the engagement surface. The volute extends around an axis and defines at least part of a flow passage through the turbine housing. The flow passage extends from the first inlet opening at a first end of the flow passage. The engagement surface of the flange is defined by a periphery of material which extends around the first inlet opening between the first inlet opening and an outer edge of the engagement surface. A thickness of a first portion of the periphery, at a radially inner side of the first inlet opening, is greater than a thickness of a second portion of the periphery, at a radially outer side of the first inlet opening, along at least a full extent of a radially inner edge of the first inlet opening.

### CROSS-REFERENCE TO RELATED PATENT APPLICATIONS

The present application is a U.S. national stage of and claims the benefit of priority to International Patent Application No. PCT/GB2023/051916, filed Jul. 20, 2023, which claims priority to GB2210653.8, filed Jul. 21, 2022, the entire contents of which are incorporated herein by reference in their entirety.

### FIELD

The present disclosure relates to a turbine housing for a turbocharger, a turbine, and turbocharger incorporating the turbine housing.

### BACKGROUND

Turbochargers are well known devices for supplying air to the intake of an internal combustion engine at pressures above atmospheric pressure (boost pressures). A conventional turbocharger comprises an exhaust-gas-driven turbine wheel mounted on a rotatable shaft within a turbine housing. Rotation of the turbine wheel drives rotation of the compressor wheel mounted on the other end of the shaft within the compressor cover. The compressor wheel delivers compressed air to the intake manifold of the engine, thereby increasing engine power.

The turbocharger shaft is conventionally supported by journal and thrust bearings, including appropriate lubricating systems, located within a central bearing housing connected between the turbine and compressor. The turbine housing and compressor housings are typically mounted to the bearing housing.

Turbine housings are relatively complex geometries to manufacture, and are generally cast using molten metal (e.g. from cast iron). Care must be taken when designing a turbine housing to ensure that molten metal material can flow throughout a mould, and access all of the cavities, to ensure that a complete, and defect-free, turbine housing casting is provided. Also of relevance is the placement of reservoirs of molten metal material (e.g. risers and feeders) which provide an outlet for gases and contaminants in the molten metal material, as well as accounting for shrinkage as the casting cools.

Existing turbine housing geometries are limited by the aforementioned casting considerations.

There exists a need to provide an alternative turbine housing which overcomes one or more of the disadvantages of known turbine housings, whether mentioned in this document or otherwise.

### SUMMARY

According to a first aspect of the disclosure there is provided a turbine housing for a turbocharger, the turbine housing comprising:
a flange, the flange having an engagement surface and a first inlet opening in the engagement surface; and
a volute which extends around an axis and defines at least part of a flow passage through the turbine housing, the flow passage extending from the first inlet opening at a first end of the flow passage;
wherein the engagement surface of the flange is defined by a periphery of material which extends around the first inlet opening between the first inlet opening and an outer edge of the engagement surface;
wherein a thickness of a first portion of the periphery, at a radially inner side of the first inlet opening, is greater than a thickness of a second portion of the periphery, at a radially outer side of the first inlet opening, along at least a full extent of a radially inner edge of the first inlet opening.

The turbine housing may be for a radial turbine. The turbine housing may be described as for a turbine. The turbine may be a fixed geometry turbine or a variable geometry turbine.

The flange may be described as a connection portion by which the turbine housing, or turbine more generally, is placed in fluid communication with a stream of incoming exhaust gas. The exhaust gas may be from an engine. The flange may have a generally cuboidal geometry (e.g. generally rectangular and having a depth). The flange may be an irregular polygon. The flange may have a thickness of around 15 mm. The flange may be generally rectangular (e.g. comprising two pairs of generally parallel sides). The flange may be generally trapezoidal (e.g. having one pair of generally parallel sides, and one pair of non-parallel sides). The flange may be said to define the first inlet opening in the engagement surface.

The first inlet opening may be the only opening in the turbine housing (e.g. a single entry turbine, or turbine housing). Alternatively, the flange may define two inlet openings. The first inlet opening may be described as an aperture or orifice. The first inlet opening, and the flange more generally, may be provided at a generally tangential position relative to the axis.

The first inlet opening may be generally rectangular, having two pairs of generally parallel sides. The two pairs of generally parallel sides may be provided with fillets at the corners (e.g. the first inlet opening having a geometry of a rectangle with arcuate corners). The first inlet opening may extend across a majority of the flange. The first inlet opening may, alternatively, be any one of generally elliptical, diamond, D and/or butterfly-shaped. Where the flange defines the first inlet opening and a second inlet opening, the first and second inlet openings are preferably substantially identical in geometry and size. The first and second inlet openings may generally mirror one another. The first inlet opening may be an irregular polygon.

The engagement surface of the flange may otherwise be described as an abutment surface or contact surface. The engagement surface may be flat. That is to say, the engagement surface may lie entirely in a single plane. The engagement surface may, in use, be engageable by an opposing engagement surface of an upstream component (e.g. a flange, or connection portion, of an exhaust manifold) through which a stream of exhaust gas flows.

The volute refers to a generally spiralling geometry which has a cross section that varies along a spiralling extent of the volute. The volute may be described as snail-shell-like. The axis around which the volute extends may be a turbine wheel axis. That is to say, it may be an axis of rotation, of a turbine wheel, when the turbine housing is assembled as part of a turbine which includes a turbine wheel.

The flow passage may be described as an exhaust gas flow passage, or a fluid pathway. The majority of the flow passage may be defined by the volute. The flow passage may be entirely defined by a combination of the volute, a nozzle, a wheel chamber and an outlet portion of the turbine housing. The flow passage extending from the first inlet opening at a first end may be described as the flow passage having the first inlet opening provided at one outer end thereof. The first inlet opening may be said to define an upstream starting point (e.g. an entry point) of the flow passage. The first end of the flow passage is preferably the end at which the flow passage has the greatest cross section area. As mentioned above, the cross sectional area (of the flow passage) may gradually reduce along the spiralling extent of the volute (or along an extent of the flow passage).

The turbine housing may further comprise an outlet opening. The flow passage may extend from the first inlet opening to the outlet opening at a second end of the flow passage. The outlet opening may be described as an outlet aperture or orifice. The outlet opening may extend axially i.e. extend along the axis. The flow passage extending from the first inlet opening to an outlet opening at a second end flow passage is intended to mean that the outlet opening defines an end point of the flow passage. That is to say. when exhaust gas first enters the turbine housing through the first inlet opening, and flows through the flow passage, it subsequently exits the turbine housing via the outlet opening. The outlet opening may be defined in an outlet portion of the turbine housing. which may define a diffuser.

The engagement surface being defined by a periphery of material may be described as the engagement surface being defined by a border, or closed loop, of material. The material extending around the first opening between the first inlet opening and the outer edge of the engagement surface may otherwise be described as the material defining a surface extending from an outer edge of the first inlet opening to the outer edge of the engagement surface. Put another way, if not for the incorporation of the first inlet opening, or of any further recesses, the engagement surface may define a solid, continuous surface (as bound by the outer edge thereof). The periphery of material has a variable geometry moving around the first inlet opening. Described another way, the periphery material is non-uniform (e.g. has a non-uniform thickness).

The thickness refers to a dimension, or extent, across the engagement surface (i.e. in the plane thereof, where the engagement surface is flat) in a generally radial direction. Where the first inlet opening is the sole inlet opening the flange, the first inlet opening may have a first major dimension in a first (e.g. axial) direction and a second major dimension in a second, perpendicular (e.g. radial) direction. The thickness may be taken perpendicular to the first major dimension or parallel to the second major dimension of the first inlet opening. The thickness may therefore be taken in an axially direction.

References to axial and radial are not intended to be limited to a precise, or ‘true’, axial direction and a precise, or ‘true’, radial direction. Instead, the references are intended to encompass a generally axial and/or generally radial direction. That is to say, the flange, for example, may have an angular offset, in one or more directions, such that the associated axial/radial directions and/or dimensions are offset by anywhere up to around 45 degrees (from a precise, or ‘true’, axial/radial direction). However, references to axial/radial are intended to also encompass a precise, or ‘true’, axial/radial direction.

The first portion of the periphery being at a radially inner side of the first inlet opening is intended to mean that the first portion of the periphery is a portion which is located closest to the axis (e.g. proximate the axis). Where the flow passage extends in a generally clockwise direction from the first inlet opening, viewed normal to the flange, the first portion of the periphery is the portion which is a lower portion of the flange. Similarly, a second portion of the periphery may be described as an upper portion of the flange when viewed normal to the flange. It will also be appreciated that the flow passage may extend in a generally counterclockwise direction, in some embodiments, but that the first portion of the periphery may still be described as a lower portion of the flange. The second portion of the periphery may be described as being located distal the axis. The first and second portions of the periphery may be said to oppose one another. The first and second portions of the peripheries may extend around the first inlet opening up to a point where an adjacent side has a relatively linear edge. Put another way, when the first inlet opening is defined by a rectangle having filleted corners, with a major dimension in the axial direction, the portions of the periphery may extend up until the end of a fillet which leads into the shorter sides. Described another way, the first and second portions may extend past the respective radially inner/outer edge of the first inlet opening, beyond a start point of a fillet which leads into a respective one of the other pair of sides. The first portion may be described as an inboard portion. The second portion may be described as an outboard portion.

The thickness of the first portion relative to the second portion is intended to refer to a dimension taken normal to a first major dimension (where the first major dimension extends in the axial direction), or parallel to the second major dimension (where the second major dimension extends in the radial direction) of the first inlet opening. For example, where a construction line is drawn across the entire flange, parts of that line define the thickness of the first and second portions, as well as part of the line extending across the first inlet opening. A thickness of a first portion of the periphery may be defined, along the construction line, from one outer edge of the engagement surface to the proximate edge of the first inlet opening. The thickness of the second portion of the periphery may be defined by a portion of the construction line which extends from the other side of the first inlet opening to a corresponding outer edge of the periphery. The rest of the construction line may extend across the first inlet opening (not defining the thickness of either the first, or second, portions of the periphery).

The thickness of the first portion being greater than a thickness of the second portion (of the periphery) along at least a full extent of a radially inner edge of the first opening may be described as a thickness of the first portion being greater than a thickness of the second portion at all positions along the first major dimension of the first inlet opening inboard of any corner fillets (if present).

The full extent of the radially inner edge (of the first inlet opening) may refer to a dimension, or length, of the first inlet opening, where the first inlet opening is rectangular and the sole opening in the flange, of a long side of the rectangle (e.g. inboard of any filleted corners of the first inlet opening). The full extent of the radially inner edge is intended to exclude any corner fillets which may be present and which may extend between an end of the radially inner edge and an adjacent side of the inlet opening. The distance ‘along at least a full extent of a radially inner edge of the first inlet opening’ may otherwise be described as ‘along a radially inner side of the first inlet opening, excluding any adjacent corner fillets’. Full extent of the radially inner edge may otherwise be described as an entire length, or total length, of the radially inner edge.

The full extent of the radially inner edge may extend in a direction parallel to one or more of a first and a second major dimension of the first inlet opening. The full extent of the radially inner edge may be collinear with the radially inner edge. The full extent of the radially inner edge may extend in a direction parallel to a proximate outer edge of the flange (e.g. a radially inner edge of the outer edge).

Where the first inlet opening is circular or elliptical, the inlet opening may be said to be defined by a radially inner edge and a radially outer edge. That is to say, the opening may be divided in two to ascertain where the radially inner edge extends from/to. For such geometries, the extent of the radially inner edge may be substantially equal to an extent of the inlet opening itself (owing to a lack of corner fillets which may otherwise define a difference between an extent of the radially inner edge and an extent of the inlet opening). The above also applies for a D-shaped inlet opening.

The radially inner edge may be linear (e.g. where the first inlet opening is rectangular). The radially inner edge may be at least partly arcuate (e.g. where the first inlet opening is butterfly-shaped). The radially inner edge may be entirely arcuate (e.g. where the first inlet opening is circular or elliptical). The radially inner edge may comprise a plurality of portions (e.g. a plurality of linear portions where the radially inner edge is generally arrowhead-shaped or diamond-shaped).

The turbine housing is preferably cast from a molten material. The turbine housing is preferably a monolithic component (e.g. a single-piece body). The flange and volute (and the turbine housing, more generally) may therefore be described as being a unitary, and uniform, body. That is to say, there may be no join line between the flange and the volute (or other features forming part of the turbine housing). A separate process (e.g. welding or brazing) may not be required in order to connect the flange and the volute. The flange and the volute may be adjoined from inception. This may be achieved by virtue of a casting process used to manufacture the turbine housing.

Advantageously, the thickness of the first portion of the periphery being greater than a second portion of the periphery means that there is a greater amount of material present on one side of the flange than the other. This can be used to facilitate changes in the casting process, providing greater flexibility for component design. In one specific example, providing the first portion of the periphery with a greater thickness than the second portion means that a reservoir of molten metal material (e.g. in the form of a feeder) may extend from the flange during the casting process (e.g. when the turbine housing is manufactured). In prior art designs, a feeder is typically provided as part of a wall which is defines the volute. Providing the reservoir of molten material on the flange, instead of the volute, means design changes can be incorporated elsewhere, in the turbine housing, without risking the turbine housing casting process leading to defects.

In one example, incorporating a reservoir of molten metal material at the flange, instead of the volute, means that the wall thickness of the volute can be reduced. This is owing to there being less need for material to flow readily through the walls of the volute during the casting process (which is otherwise needed for a reservoir, extending from the volute, to perform its function). For completeness, it will be appreciated that during the casting process molten metal cools and shrinks and, in thicker wall sections, will cool down more slowly (than thinner wall sections). Thinner walls will typically cool quicker which can, in some instances, lead to an undesirable “freezing off” of thicker sections which are downstream of a thin section (relative to a reservoir of molten metal material). Providing a reservoir of molten metal material on the flange, specifically the first portion of the periphery thereof, effectively decouples of the thickness of the volute wall from the quality of the turbine housing casting. Reducing the thickness of the volute wall may be desirable for reasons of, for example, increasing the speed at which the turbine housing heats up in operation, such that more heat is transferred to a downstream aftertreatment system (rather than being transferred to the turbine housing, by convection, during engine start up). The downstream exhaust aftertreatment system may thus reach an activation, or operation, temperature more swiftly than if the turbine housing had comparatively thicker walls.

The aforementioned advantages are obtained due to the first portion having a greater thickness, than the second portion, and the molten metal material being able to flow through a flange cavity in the mould when the turbine housing is cast. The first portion is also radially closer to an outlet portion of the turbine housing, than the second portion, which typically has the thickest walls. Providing the thicker first portion therefore provides a desirable balance of proximity to thicker wall sections, along with a greater volume through which molten metal material can flow during the casting process.

The full extent of the radially inner edge of the first inlet opening may be a full axial extent of the radially inner edge of the first inlet opening.

The thickness of the first portion of the periphery may be greater than the thickness of the second portion of the periphery along at least a full extent of the first inlet opening.

The full extent of the first inlet opening may otherwise be described as a length of the first inlet opening along the first major dimension. The full extent may be a full axial extent. The distance ‘along at least a full extent of the first inlet opening’ may otherwise be described as ‘along a radially inner side of the first inlet opening, including any adjacent corner fillets’.

Advantageously, the thickness of the first portion of the periphery being greater than the thickness of the second portion of the periphery along at least the full extent of the first inlet opening provides a greater volume through which molten material can flow into the mould (specifically portions of a flange cavity downstream of where the first portion geometry is defined) during casting.

The thickness of the first portion of the periphery may be greater than the thickness of the second portion of the periphery along a full extent of a radially inner edge of the outer edge of the engagement surface.

The full extent of the radially inner edge of the outer edge of the engagement surface may be described as a length of a major side of the engagement surface excluding any fillets. The full extent of the radially inner edge of the outer edge of the engagement surface may be a linear edge, or may comprise one or more arcuate portions. The full extent may be a full axial extent.

The thickness of the first portion of the periphery being greater than the thickness of the second portion of the periphery along the full extent of the radially inner edge of the outer edge of the engagement surface advantageously provides a greater volume through which cast metal material can flow during the casting process.

The radially inner edge of the first inlet opening may comprise one or more linear portions.

The radially inner edge may consist of a single linear portion (e.g. where the first inlet opening is rectangular). The radially inner edge may comprise a plurality of linear portions (e.g. where the first inlet opening is butterfly-shaped or diamond-shaped). Linear portion is intended to mean a straight line geometry.

The radially inner edge of the first inlet opening may be linear.

The radially inner edge of the first inlet opening being linear is intended to mean that the radially inner edge is a straight edge. Put another way, the radially inner edge is not arcuate. The radially inner edge may be described as entirely linear. The radially inner edge may be a radially innermost edge of the first inlet opening.

The radially inner edge of the first inlet opening may be at least partly arcuate.

The radially inner edge of the first inlet opening may be arcuate.

The radially inner edge may be described as entirely arcuate. The radially inner edge may be a radially innermost edge of the first inlet opening.

The volute may defines an outer volute surface, wherein a surface extends between at least part of a radially inner edge of the outer edge of the engagement surface and the outer volute surface.

The outer volute surface may be described as an exterior of the volute. The surface may only extend along a portion of the radially inner edge of the outer edge of the engagement surface.

The surface may be described as a blend. Advantageously, the presence of the surface, in comparison to, for example, no material, provides a path for molten metal material to flow through during the casting process of the turbine housing. This is particularly desirable when the reservoir of material extends from the flange, as it provides a path for the molten metal material, in the reservoir, to flow through to other parts of the mould.

The surface may comprise a fillet having a radius of at least around 10 mm.

Advantageously, a fillet having a radius of at least 10 mm has been found to facilitate the flow of molten metal material from the reservoir, through the flange, into the rest of the turbine housing geometry during casting. This reduces the risk that molten metal material does not fill the entire mould.

Incorporation of a fillet having a radius of at least around 10 mm has been found to provide improved thermomechanical fatigue performance.

The surface may comprise a fillet having a radius of around 15 mm.

A fillet having a radius of around 15 mm has been found to be particularly advantageous in facilitating the flow of molten metal material through the mould during casting.

The fillet may be defined in an entirely arcuate surface.

The surface being entirely arcuate improves the fatigue performance of the turbine housing, in operation, by reducing the risk of cracks propagating at any otherwise comparatively sharp corners, or smaller radius fillets.

The turbine housing may further comprise an outlet opening defined in an outlet portion.

The outlet opening may define an outer end of the outlet portion. The outlet opening may be an outer edge of the outlet portion. The outlet portion may be generally tubular. The outlet portion may comprise a diffuser. The outlet portion may extend in an axial direction along the axis.

The outlet portion may comprise one or more connection features to facilitate the attachment of the outlet portion to a downstream conduit.

The turbine housing may be a thin-walled turbine housing.

A thin-walled turbine housing may be defined as a turbine housing having a wall thickness, for at least the volute, of less than around 5 mm at sidewalls thereof and/or less than around 6 mm at a circumferentially outer surface thereof (e.g. the combination of the sidewalls, and the circumferentially outer surface extending therebetween, defining a U-shape).

A thin-walled turbine housing may be defined as a turbine housing having a wall thickness, for at least the volute, of less than around 12%, more preferably less than around 10%, further preferably less than around 8%, of a minimum diameter of the diffuser. All wall thicknesses of at least the volute may be less than around 12%, more preferably less than around 10%, further preferably less than around 8%, of the minimum diameter of the diffuser. Alternatively, only a minimum wall thickness of at least the volute may be less than around 12%, more preferably less than around 10%, further preferably less than around 8%, of the minimum diameter of the diffuser. Wall thicknesses include thicknesses at sidewalls and/or a circumferentially outer surface of the volute. The minimum diameter of the diffuser may be located within the outlet portion distal the outlet opening (i.e. proximate a rear side of the housing).

Advantageously, providing a thin-walled turbine housing means that the turbine housing heats up faster, in use, and that the heat transfer from the exhaust gas flow to the turbine housing is reduced more swiftly (following key-on). This means that exhaust aftertreatment devices, downstream of the turbine, are heated up more swiftly (e.g. to an activation, or operational temperature) following key-on. Harmful emissions, which may otherwise not be catalysed by the aftertreatment devices (and thus be exhausted into the atmosphere), are thus reduced more swiftly than if the turbine housing was a comparatively thicker-walled turbine housing (which may absorb more heat, from the exhaust gas, for a greater period of time following key-on).

Thin-walled turbine housings can prove comparably difficult to cast, owing to the thinner walls of material cooling, or becoming solidified, before comparatively thicker sections of the turbine housing. This can lead to the risk of thicker sections being “frozen off” in the casting process (e.g. a fluid pathway, of molten metal material, to the thicker sections being blocked by the thinner sections). That is to say, if a comparably thicker section is downstream of a comparably thinner section (relative to a source of molten metal material), the molten material of the thinner section may cool first, before material has properly filled the mould around the thicker section. Providing the thickened first portion of the periphery facilitates the incorporation of a reservoir of material on the first portion of the periphery (of the flange), providing greater material flow to the rest of the turbine housing geometry, even when the turbine housing is a thin-walled turbine housing.

The engagement surface may comprise a plurality of bores.

One or more of the plurality of bores may be threaded bores. The bores may be configured to receive a fastener, such as a bolt, or may be configured to receive a peg.

The plurality of bores may facilitate the attachment, or engagement, of the flange to an upstream conduit (e.g. an exhaust manifold). The bores may be referred to as bolt holes. One or more of the bores may be threaded. One or more of the bores may be through bores. The bores may be described as cavities.

The flange may further define a second inlet opening in the engagement surface of the flange; wherein the engagement surface is defined by a periphery of material which extends around the first and second inlet openings between the first and second inlet openings and the outer edge of the engagement surface; and
wherein the first portion of the periphery is disposed at a radially inner side of the first and second inlet openings, and the second portion of the periphery is disposed at a radially outer side of the first and second inlet openings.

A turbine housing comprising two inlet openings may be described as a twin-entry turbine housing. Both inlet openings may define ends of the volute, which may be split by a dividing wall.

The thickness of the first portion of the periphery may be greater than the thickness of the second portion of the periphery along at least a full extent of a radially inner edge of the first and (optionally) second inlet openings. The at least a full extent of a radially inner edge of the first and second inlet openings is intended to exclude the dividing wall which extends between the first and second inlet openings.

The first portion of the periphery may be disposed at a radially inner side of each of the first and second inlet openings. The second portion of the periphery may be disposed at a radially outer side of each of the first and second inlet openings.

The thickness of the first portion of the periphery may be greater than the thickness of the second portion of the periphery along at least a full extent of a radially inner edge of each of the first and second inlet openings.

The thickness of the first portion of the periphery may be greater than the thickness of the second portion of the periphery along at least a full extent of each of the first and second inlet openings.

The at least a full extent of the radially inner edge of each of the first and second inlet openings excludes a dividing wall which extends between the inlet openings. The full extent may be a full axial extent.

The thickness of the first portion of the periphery may be greater than the thickness of the second portion of the periphery along a full extent of the radially inner edge of the outer edge of the engagement surface.

The full extent may be a full axial extent. Along a full extent of the radially inner edge of the outer edge of the engagement surface excludes a dividing wall which extends between the inlet openings.

The thickness of the first portion of the periphery may vary along at least the full extent of the radially inner edge of the first inlet opening.

Described another way, the first portion of the periphery has a non-uniform thickness along at least the full extent of the radially inner edge of the first inlet opening. The thickness of the first portion of the periphery may increase, or decrease, in a direction moving from an axially rear side of the first inlet opening towards an axially front side first inlet opening. The thickness of the first portion may increase, or decrease, along a distance corresponding to at least the full extent of the radially inner edge of the first inlet opening. The thickness may vary continuously (e.g. an extent of a radially inner edge of the outer edge of the engagement surface may be inclined at a generally constant angle relative to a corresponding extent of the radially inner edge of the first inlet opening). The first portion of the periphery may be generally trapezoidal, at least along a full extent of the radially inner edge of the first inlet opening. Described another way, in a region corresponding to at least the full extent of the radially inner edge of the first inlet opening, the first portion of the periphery may be defined by two pairs of sides, both sides of one of the pairs being parallel to one another, and one side of the other pair being inclined at an angle relative to the other side of that pair.

The thickness of the first portion of the periphery may vary along at a least a full extent of the first inlet opening (e.g. parallel to a first major dimension of the first inlet opening). The thickness of the first portion of the periphery may vary along at least a full extent of the radially inner edge of the outer edge of the engagement surface.

Advantageously, providing a variable thickness of the first portion of the periphery facilitates improvements in the casting process where, for example, a reservoir of molten metal material, in the form of a feeder, may extend from the first portion of the periphery during the casting process. This can facilitate design changes elsewhere in the turbine housing without negatively impacting the manufacturing process.

The thickness of the first portion of the periphery may decrease in a direction moving from an axially rear side of the first inlet opening towards an axially front side of the first inlet opening.

The thickness of the first portion of the periphery preferably decreases continuously (e.g. linearly) moving from the axially rear side of the first inner opening towards the axially front side. In other embodiments, the thickness may not decrease continuously. In a region corresponding to at least the full extent of the radially inner edge of the first inlet opening, the first portion of the periphery may be generally trapezoidal in shape.

The thickness of the first portion of the periphery may decrease along at least the full extent of the radially inner edge of the first inlet opening. The thickness of the first portion of the periphery may decrease along at least the full extent of the first inlet opening. The thickness of the first portion of the periphery may decrease along at least a full extent of the radially inner edge of the outer edge of the engagement surface.

Advantageously, the thickness of the first portion of the periphery decreasing in a direction moving from the axially rear side of the first inlet opening towards the axially front side means that a reservoir of molten metal material, e.g. in the form of a feeder, can be placed in fluid communication with a thicker region of the first portion of the periphery during casting. The point of entry of the molten metal material into the turbine housing mould can therefore have a comparatively larger cross-sectional area (e.g. such that a greater volume of molten metal material can flow therethrough) and is therefore better protected from undesirable freezing (i.e. cooling, solidification and blocking) during casting. This is owing to the fact that higher volumes of molten metal material will cool more slowly, during casting, due to the increased thermal inertia. This is of particular importance for the reservoir, which functions to provide a supply of molten metal material to the mould as the other molten metal material cools and contracts. That is to say, it is desirable that the entry point of the reservoir to the turbine housing mould (e.g. through the first portion) be one of the last, if not the last, part of the newly-cast turbine housing to cool and solidify.

According to a second aspect of the disclosure there is provided a turbine comprising:
the turbine housing according to the first aspect of the disclosure; and
a turbine wheel, the turbine wheel being received by the turbine housing.

The turbine may be a fixed geometry turbine. The geometry may be a variable geometry turbine. The turbine may comprise a wastegate.

According to a third aspect of the disclosure there is provided a turbocharger comprising:
the turbine according to the second aspect of the disclosure;
a bearing housing configured to support a shaft for rotation about the axis; and
a compressor, the compressor comprising a compressor housing and a compressor wheel;
wherein the turbine wheel and compressor wheel are in power communication.

The turbocharger may be a fixed geometry turbocharger. The turbocharger may be a variable geometry turbocharger. The turbocharger may form part of an engine arrangement e.g. for a vehicle or a pump.

The bearing housing may support the shaft for rotation by one or more bearing assemblies. The bearing assemblies may comprise journal and/or thrust bearings. The turbine wheel and compressor wheel being in power communication with one another is intended to mean that rotation of one of the turbine wheel or compressor wheel drives rotation of the other of the compressor wheel and the turbine wheel. In operation, when the turbocharger is being used, exhaust gas drives the turbine wheel which, in turn, drives the compressor wheel to provide a boost pressure.

According to a fourth aspect of the disclosure there is provided a turbine housing for a turbocharger, the housing comprising:
a flange, the flange having an engagement surface and a first inlet opening in the engagement surface; and
a volute which extends around an axis and defines at least part of a flow passage through the turbomachine housing, the flow passage extending from the first inlet opening at a first end of the flow passage;
wherein the engagement surface of the flange is defined by a periphery of material which extends around the first inlet opening between the first inlet opening and an outer edge of the engagement surface, the periphery comprising a pair of opposing axially disposed sides, and a pair of opposing radially disposed sides which extend between the pair of axially disposed sides;
wherein a thickness of a first of the pair of axially disposed sides, at a radially inner side of the first inlet opening, is greater than a thickness of a second of the pair of axially disposed sides, at a radially outer side of the first inlet opening, along an entire length of a radially inner side of the first inlet opening.

The turbine housing may further comprise an outlet opening. The flow passage may extend from the first inlet opening to the outlet opening at a second end of the flow passage.

The entire length of the radially inner side of the first inlet opening may otherwise be described as a full extent of a radially inner edge of the first inlet opening.

According to a fifth aspect of the disclosure there is provided a turbine housing for a turbocharger, the housing comprising:
a flange, the flange having an engagement surface and a first inlet opening in the engagement surface; and
a volute which extends around an axis and defines at least part of a flow passage through the turbomachine housing, the flow passage extending from the first inlet opening at a first end of the flow passage;
wherein the engagement surface of the flange is defined by a periphery of material which extends around the first inlet opening between the first inlet opening and an outer edge of the engagement surface, the periphery comprising a pair of opposing axially disposed sides, and a pair of opposing radially disposed sides which extend between the pair of axially disposed sides;
wherein a first of the pair of axially disposed sides, at a radially inner side of the first inlet opening, has a greater surface area than a second of the pair of axially disposed sides, at a radially outer side of the first inlet opening.

The turbine housing may further comprise an outlet opening. The flow passage may extend from the first inlet opening to the outlet opening at a second end of the flow passage.

### BRIEF DESCRIPTION OF THE DRAWINGS

Specific embodiments of the present disclosure will now be described, by way of example only, with reference to the accompanying drawings, in which:

FIG. 1 is a perspective view of a turbine housing according to an embodiment;

FIG. 2 is an alternative perspective view of the turbine housing of FIG. 1;

FIG. 3 is a side view of the turbine housing of FIGS. 1 and 2;

FIG. 4 is a front view of the turbine housing of FIGS. 1 to 3;

FIG. 5 is a magnified view of the flange, and surrounding structure, of the turbine housing of FIGS. 1 to 4;

FIGS. 6 to 10 are magnified views of the flange, of the turbine housing of FIGS. 1 to 5, taken normal to an engagement surface of the flange and with various features schematically labelled thereon;

FIG. 11 is an alternative perspective view of the flange, and surrounding structure, of the turbine housing of FIGS. 1 to 5;

FIG. 12 is a schematic illustration of a twin-entry turbine housing flange in accordance with another embodiment;

FIG. 13 is a perspective cross section view of the turbine housing of FIGS. 1 to 11;

FIG. 14 is a schematic illustration of the turbine housing, shown in FIG. 13, including features of relevance to the casting process;

FIG. 15 is a perspective view of the flange before the feeder pad is removed;

FIGS. 16 to 22 are schematic close-up views of various flanges according to other embodiments; and

FIGS. 23 to 27 are magnified views of a flange, of a turbine housing according to another embodiment, taken normal to an engagement surface of the flange and with various features schematically labelled thereon.

### DETAILED DESCRIPTION OF THE DRAWINGS

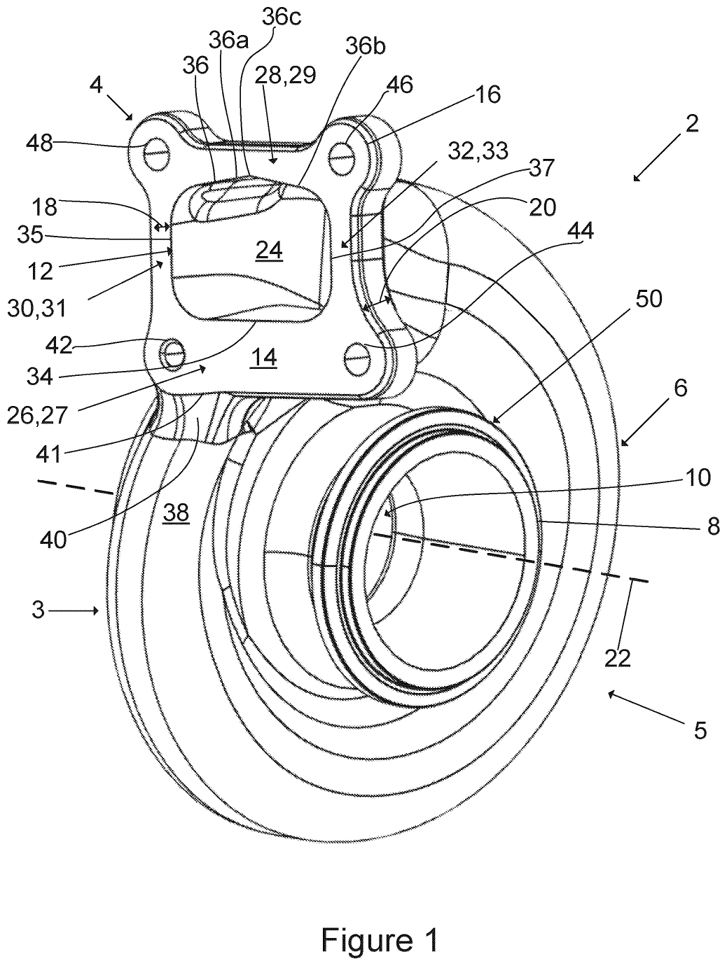

FIG. 1 is a perspective view of a turbine housing 2 in accordance with the embodiment of the present disclosure.

The turbine housing 2 comprises a flange 4, a volute 6 and an outlet opening 8.

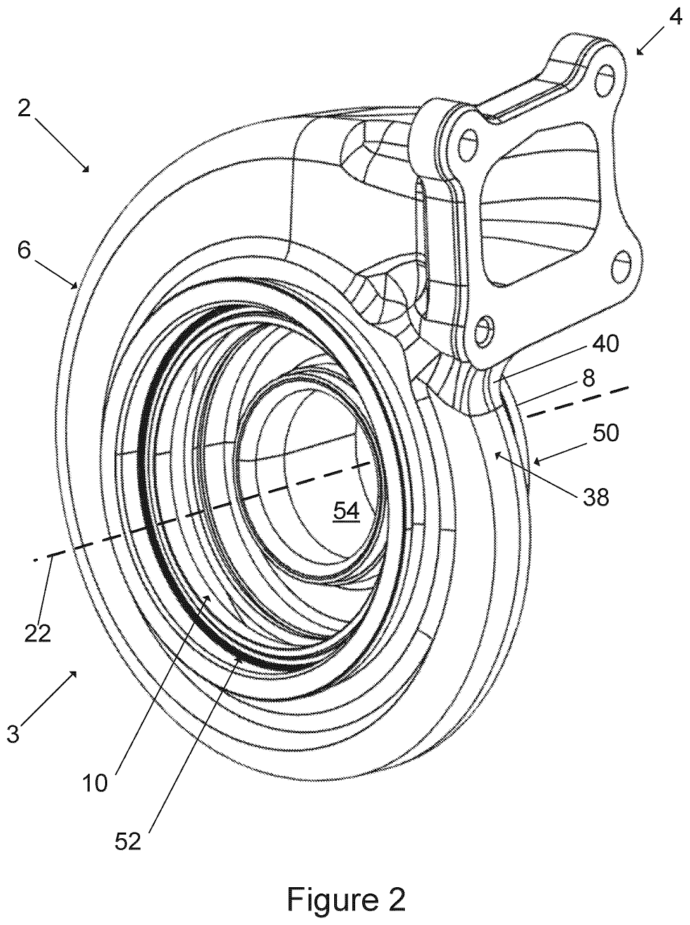

In use, the turbine housing 2 is secured to an adjacent bearing housing (at a rear side 3 of the turbine housing 2) and forms part of a turbocharger. The turbine housing 2 receives a turbine wheel (not shown) in a wheel chamber 10 (also shown in FIG. 2). Exhaust gas is expanded across the turbine wheel. The expansion of exhaust gases across the turbine wheel drives rotation of the turbine wheel which, in turn, drives rotation of a compressor wheel mounted to the same shaft as the turbine wheel. Such operation of turbocharges is well-known.

Returning to the turbine housing 2, the flange 4 is of particular relevance to the present application. The flange 4 defines a first inlet opening 12. The first inlet opening 12 may be the only such opening in the flange 4, or, in some embodiments, such as a twin-entry turbine housing, a plurality of inlet openings (e.g. two) may be defined in the flange 4. The first inlet opening 12 may otherwise be described as an inlet of the turbine housing 2.

The first inlet opening 12 is defined in an engagement surface 14 forming part of the flange 4. Engagement surface 14 is flat such that the entirety of engagement surface 14 lies in a single plane.

The engagement surface 14 of the flange 4 is defined by a periphery of material 18 which extends around the first inlet opening 12 between the first inlet opening 12 and an outer edge 16 of the engagement surface 14. Described another way, the engagement surface 14 is defined by a surface which is bound between the outer edge 16 and the first inlet opening 12. The periphery of material 18 may be described as a perimeter, or border, of sorts. One portion of the periphery of material is labelled 18 in FIG. 1.

The flange 4 extends by a thickness 20, which is around 15 mm in the illustrated embodiment. In other embodiments the thickness 20 may be between around 10 mm and around 20 mm.

Turning to describe the volute 6, the volute 6 extends around an axis 22. The axis 22 may otherwise be described as an axis of rotation about which the turbine wheel (not shown in FIG. 1) rotates. The volute 6 is so-called because it refers to a generally spiralling geometry, and has a cross section that varies along an extent of the volute 6. The volute 6 may be said to have a generally reducing, or tapering, cross section. The volute 6 defines part of a flow passage 24 through the turbine housing 2. The flow passage 24 may otherwise be described as a fluid pathway through the turbine housing 2. The flow passage 24 extends from the first inlet opening 12 (at a first end, or inlet, of the flow passage 24) to the outlet opening 8 at a second end of the flow passage 24. A cross section of the flow passage 24 at the inlet end is therefore defined by the first inlet opening 12. In use, the volute 6 directs exhaust gases onto the turbine wheel (as will be described in more detail in connection with FIG. 2) via a nozzle (52 in FIG. 2).

Returning to FIG. 1, a particular focus of the present disclosure relates to the geometry of the flange 4, and specifically the engagement surface 14. The periphery of material 18, which defines the engagement surface 14, comprises a first portion 26, a second portion 28 and third and fourth portions 30, 32.

The first portion 26 of the periphery 18 is generally located at a radially inner side 27 of the first inlet opening 12 (e.g. adjacent a radially inner edge 34 of the first inlet opening 12). The radially inner reference is with respect to the axis 22. The radially inner reference is used to describe which general side of the first inlet opening 12 the first portion 26 is provided at (or is disposed at). Furthermore, the radially inner edge should be interpreted as a ‘generally’ radially inner edge. As will be appreciated from FIG. 4, a plane in which the engagement surface 14 lies is not a precise radial plane with respect to the axis 22. In other embodiments, the engagement surface may lie in a precisely radial plane with respect to the axis 22.

Returning to FIG. 1, the second portion 28 of the periphery 18 is disposed at a radially outer side 29 of the first inlet opening 12 (e.g. adjacent a radially outer edge 36 of the first inlet opening 12). As described in connection with the first portion 26, the radially outer position of the second portion 28 should be interpreted as ‘generally’ radially outer.

The radially outer edge 36 comprises two linear portions 36a and 36b in the illustrated embodiment. The radially outer edge 36 refers to the collective two portions, rather than the radially outermost tip 36c, or arrowhead, defined by the two linear portions 36a, 36b.

The third and fourth portions 30, 32 of the periphery 18 extend between the first and second portions 26, 28. The third portion 30 of the periphery 18 is disposed at an axially rear side 31 of the first inlet opening 12 (e.g. adjacent an axially rear edge 35 of the first inlet opening 12). The axially rear reference refers to a side/edge which is proximate the rear side 3 of the turbine housing 2 (which is connected to the bearing housing when assembled as part of a turbocharger). The fourth portion 32 of the periphery 18 is disposed at an axially front side 33 of the first inlet opening 12 (e.g. adjacent an axially front edge 37 of the first inlet opening 12). The axially front reference refers to a side/edge which is proximate a front side 5 of the turbine housing 2.

The engagement surface 14, defined by the periphery 18 of material, may be defined entirely by the combination of the first, second, third and fourth portions 26, 28, 30, 32.

The first and second portions 26, 28 may be described as being a pair of axially disposed sides. This is owing to the fact that the first and second portions 26, 28 generally extend in an axial direction. Put another way, a major dimension of the first and second portions 26, 28 is generally in an axial direction. The third and fourth portions 30, 32 may be described as a pair of radially disposed sides owing to the third and fourth portions 30, 32 having major dimensions in a generally radial direction.

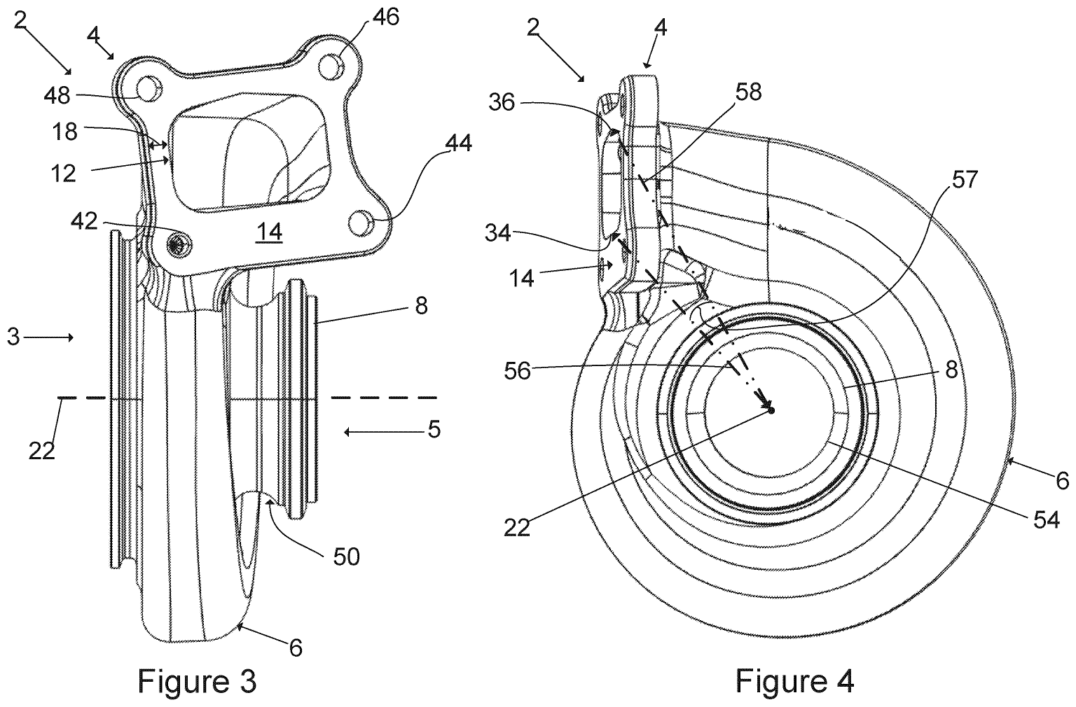

For completeness, and for reasons that will be appreciated from, for example, FIG. 3, references to axial and radial, throughout this document, are not intended to be strict references to a precise axial and a precise radial direction. Instead, the references are intended to refer to a generally axial or generally radial direction. That is to say, the flange, for example, may have an angular offset, in one or more directions, such that the described ‘axial’ dimensions may be offset by anywhere up to around 45 degrees (from a precise, or ‘true’ axial direction—e.g. the direction in which axis 22 extends). However, in some embodiments, the ‘axial’ references may be a true, or precise, axial direction.

As will be described in greater detail later in this document, it has been found that by increasing a thickness of the first portion 26 of the periphery 18, relative to the second portion 28 of the periphery 18, a wider variety of turbine housing geometries can be manufactured using a casting process. Specifically, by increasing the thickness of the first portion 26, relative to the second portion 28, a reservoir of molten metal material can be incorporated at the first portion 26 of the periphery 18 when the turbine housing 2 is cast (i.e. using a molten metal material). Providing the reservoir of material at the first portion 26 of the periphery 18, as opposed to alternative locations around the turbine housing, advantageously reduces the risk that certain sections of the turbine housing 2 become “frozen off” by molten metal material in the thinner sections of the housing cooling, and solidifying, before comparatively thicker sections (during the casting process).

Returning to FIG. 1, the volute 6 defines an outer volute surface 38, which may otherwise be described as an exterior of the volute 6. In the illustrated embodiment, a surface 40 extends between the outer volute surface 38 and a radially inner edge 41 of the outer edge 16 of the engagement surface 14. The surface 40 is an entirely arcuate surface in the illustrated embodiment, and incorporates a fillet having a radius of at least around 10 mm. Advantageously, the incorporation of said fillet, and the arcuate surface, has been found to aid in the flow of molten metal material from the aforementioned reservoir, provided at the first portion 26 of the periphery 18, to the rest of the turbine housing 2 geometry, during the casting process.

The engagement surface 14 of the flange 4 comprises a plurality of bores 42, 44, 46, 48. The plurality of bores are generally disposed at a respective corner of the flange 4, and are configured to receive a fastener. The bores 42, 44, 46, 48 may thus be described as bolt holes. This facilitates securing the flange to an upstream conduit (e.g. an exhaust manifold). A gasket may be provided between the engagement surface 14 and an upstream component.

In some embodiments, the plurality of bores 42, 44, 46, 48 may be omitted and the flange 4 may be secured to an upstream component using alternative means (e.g. a V-band clamp).

The outlet opening 8 is defined in an outlet portion 50 of the turbine housing. The outlet portion 50 may comprise a diffuser.

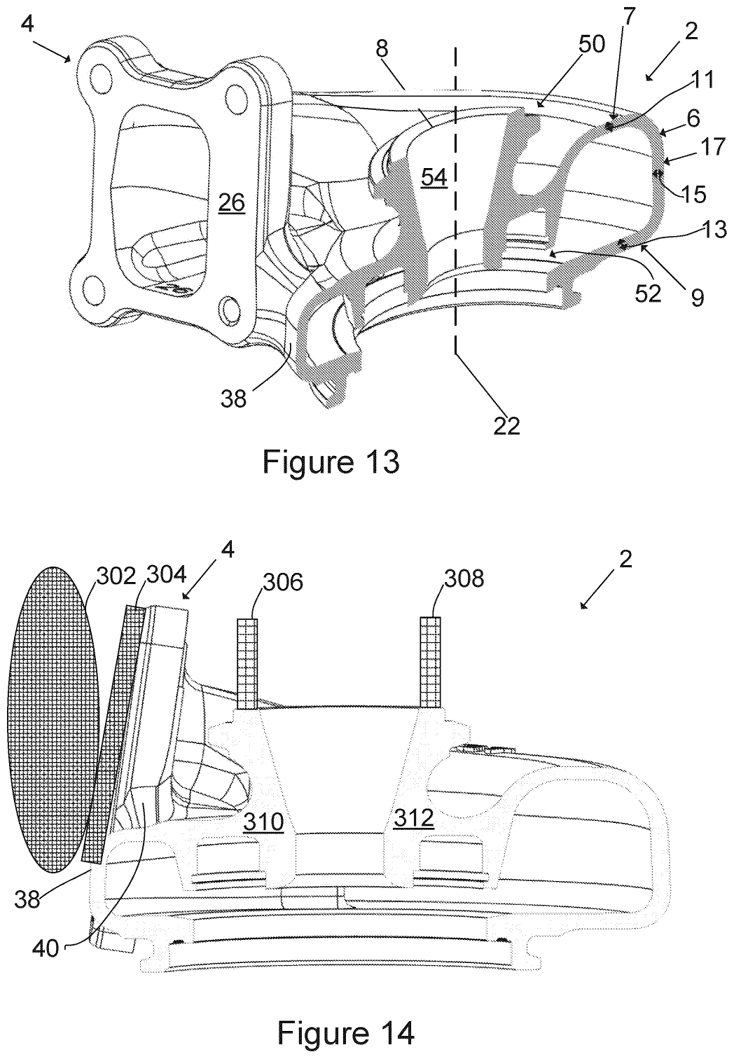

The turbine housing 2 is cast from a molten material. The turbine housing 2 is a monolithic component (e.g. a single-piece body). Each of the flange 4, volute 6 and outlet portion 50 are thus integral with one another. Put another way, no separate joining process is required to connect the flange 4, volute 6 and outlet portion 50. This will also be appreciated from FIGS. 13 and 14, which will be described in detail later in this document.

Turning to FIG. 2, an alternative perspective view of the turbine housing 2 is provided. FIG. 2 generally shows the rear side 3 of the turbine housing 2.

Many of the features shown in FIG. 2 are described in detail in connection with FIG. 1, and will therefore not be described in detail in connection with FIG. 2.

FIG. 2 shows the turbine housing 2 generally from a rear side of the turbine housing 2. That is to say, the side shown in FIG. 2 is the side which, when assembled as part of a turbocharger, the turbine housing 2 is attached to a bearing housing by.

The wheel chamber 10 is more clearly visible in FIG. 2, the wheel chamber 10 being a volume in which a turbine wheel is received in use. As previously mentioned, the turbine wheel rotates about the axis 22. Also visible in FIG. 2 is a nozzle 52 which interposes the volute 6 and the wheel chamber 10. In use, the nozzle 52 directs exhaust gas, which flows through the volute 6, onto the blades of the turbine wheel. A diffuser 54 of the outlet portion 50 is also visible. The nozzle 52 defines a throat (i.e. narrowest point) of the flow passage.

The surface 40, which extends between the flange 4 and the outer volute surface 38, is also shown from another perspective in FIG. 2.

Turning to FIG. 3, a side view of the turbine housing 2 is provided. Like that described in connection with FIG. 2, many of the features shown in FIG. 3 have already been described in detail in connection with FIG. 1 (and will therefore not be described again in detail).

The axis 22 extending through the turbine housing 2 is illustrated, and the outlet opening 8 being provided at a distal end of the outlet portion 50 is also shown. Front and rear sides 5, 3 of the turbine housing are also indicated.

As will be appreciated from FIGS. 3 and 4, the flange 4 is offset, or twisted, slightly in multiple directions.

Returning to FIG. 3, the engagement surface 14 of the flange 4 is also labelled, along with the periphery 18 of material, the first inlet opening 12 and each of the first to fourth bores 42, 44, 46, 48.

Turning to FIG. 4, a front view of the turbine housing 2 is provided. The flange 4 is shown along with the volute 6, the axis 22, the diffuser 54 and outlet opening 8. FIG. 4 indicates the twisting of the engagement surface 14 plane of the flange 4 as mentioned in connection with FIG. 3, although this twisting is not a focus of the present application.

From the FIG. 4 view it will be appreciated that the volute 6 extends around the axis 22. Furthermore, it will also be appreciated that the outlet portion 50, defining the diffuser 54 and the outlet opening 8, projects in the axial direction (collinear with the axis 22).

The radially inner edge 34 of the first inlet opening 12 has a radial position as indicated by the dimension marker 56 relative to the axis 22. The radially outer edge 36 of the first inlet opening 12 has a radial position indicated by the dimension marker 58 relative to the axis 22. Owing to the slight twisting of a plane, which the engagement surface 14 lies in, there is an angular offset 57 between the radial dimension markers 56, 58 which indicate the position of the radially inner and outer edges 34, 36 of the first inlet opening 12.

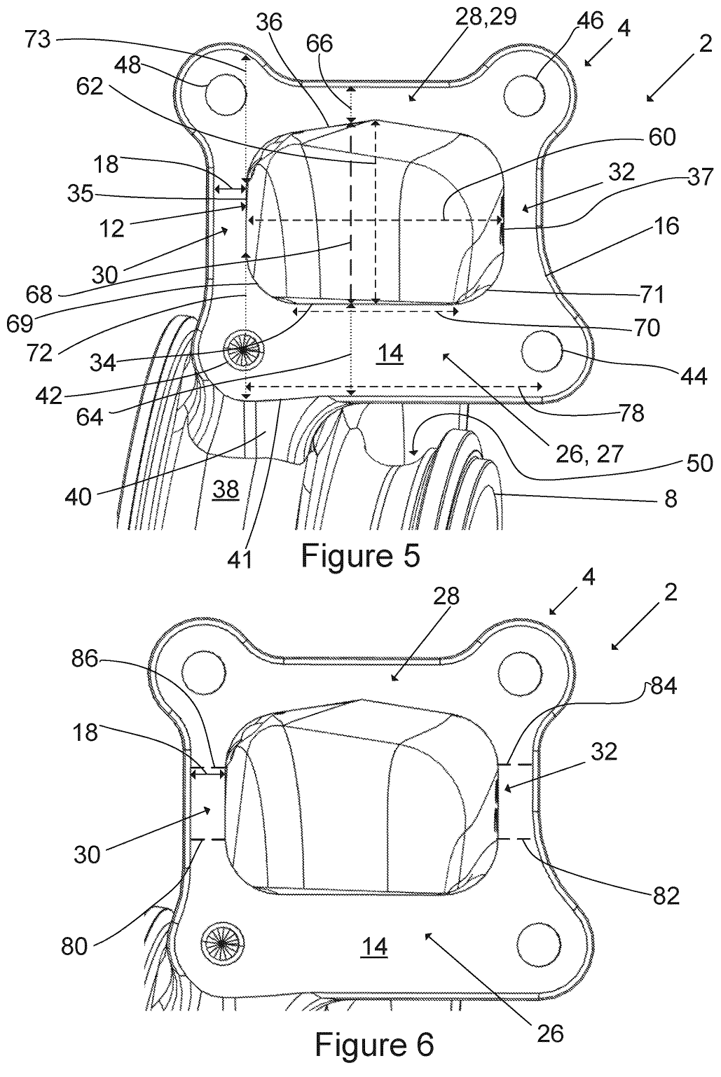

Turning now to FIG. 5, a close-up view of the flange 4 and surrounding geometry of the turbine housing 2 is provided.

As described in connection with earlier Figures, the flange 4 comprises the engagement surface 14 which is defined by the periphery 18 of material. The periphery 18 extends around the first opening 12 from the first inlet opening 12 to the outer edge 16 of the engagement surface 14. It will also be recalled that the engagement surface 14 lies in a plane (i.e. it is flat).

The periphery 18 comprises the first portion 26, provided at the radially inner side 27 of the first inlet opening 12 (e.g. adjacent the radially inner edge 34 of the first inlet opening 12). The periphery 18 further comprises the second portion 28 which is provided at the radially outer side 29 of the first inlet opening 12 (i.e. adjacent the radially outer edge 36 of the first inlet opening 12). Third and fourth portions 30, 32 of the periphery 18 extend between the first and second portions 26, 28. The first and second portions 26, 28 may be described as being a pair of axially disposed sides (which are radially separated). The third and fourth portions 30, 32 may be described as a pair of radially disposed sides (being axially separated).

The first inlet opening 12 has first and second major dimensions 60, 62. The first and second major dimensions 60, 62 extend in axial and radial directions respectively. However, it will be recalled that the axial and radial directions may otherwise be described as generally axial and generally radial with respect to true axial/radial directions as defined by the axis 22. As suggested by the name, the first and second major dimensions 60, 62 define the greatest separation of the two pairs of generally parallel sides which define the first inlet opening 12 (e.g. 34, 36 and 35, 37). For example, the first major dimension 60 is the maximum extent by which the radially outer edge 36 of the first inlet opening 12 is separated from the radially inner edge 34 of the first inlet opening 12. If the first inlet opening 12 was rectangular, with no corner fillets, the first major dimension 60 would be a length of the longer sides of the rectangle, and the second major dimension 62 would be a length of the shorter sides of the rectangle. The first major dimension 60 and second major dimension 62 define an area (e.g. a rectangle in the illustrated embodiment) which would fully enclose, or surround, the first inlet opening 12 (even in the illustrated embodiment). The first major dimension may be described as a width of the first inlet opening 12. The second major dimension 62 may be described as a height of the first inlet opening 12.

In accordance with the disclosure, a thickness 64 of the first portion 26 of the periphery 18 is greater than a thickness 66 of the second portion 28 of the periphery 18 across varying lengths, or extents 70, 60, 78.

The thickness refers to an extent across the engagement surface 14 taken in a radial direction. The direction of the thickness is parallel to the second major dimension 62 in the illustrated embodiment, and so perpendicular to the first major dimension 60.

One instance of the aforementioned thickness is labelled 64 in FIG. 5, which indicates the thickness of the first portion 26 of the periphery 18 at one point 62 along the radially inner edge 34 of the first inlet opening 12. It will also be appreciated that the thickness 64 is taken perpendicular to the radially inner edge 34 of the first inlet opening 12. In order to be able to compare the thickness 64 of the first portion 26 with the thickness 66 of the second portion 28, two further lines are drawn on FIG. 5, labelled 66 and 68 respectively. Firstly, the dimension line 66 indicates the thickness of the second portion 28 of the periphery 18 at the same position as the thickness 64 of the first portion 26. The line 68 extends between the two thickness lines 64, 66, across the first inlet opening 12 and perpendicular to the first major dimension 60, to indicate that the first thicknesses 64, 66 are taken at the same position along the first inlet opening 12.

As will be appreciated from FIG. 5, the thickness 64 of the first portion 26 of the periphery 18 is greater than the thickness 66 of the second portion 28 of the periphery 18 at the position indicated by the line 68. In the illustrated embodiment, the thickness 64 of the first portion 26 of the periphery 18 is around 25 mm. In other embodiments the thickness 64 may be between around 20 mm and around 30 mm, more preferably between around 24 mm and around 26 mm. In the illustrated embodiment, the thickness 66 of the second portion 28 of the periphery 18 is around 9 mm. In other embodiments the thickness 66 may be between around 5 mm and around 15 mm, more preferably between around 8 mm and around 13 mm. A minimum thickness of the second portion 28 of the periphery 18 is preferably at least around 5 mm, more preferably at least around 8 mm.

In the illustrated embodiment the thickness 64 of the first portion 26 of the periphery 18 is greater than a thickness 66 of the second portion 28 of the periphery 18 along a full (e.g. entire) extent 70 of the radially inner edge 34 of the first inlet opening 12. That is to say, along each of the positions along the extent 70, the thickness 64 of the first portion 26 is greater than the thickness 66 of the second portion 28. For completeness, the indicated thicknesses 64, 66, as mentioned above, indicate only a thickness at one given position, as indicated by the line 68. The extent 70 may be an axial extent.

The full extent 70 of the radially inner edge 34 may otherwise be described as generally parallel to a precise axial direction because, as mentioned above in connection with first and second major dimensions 60, 62, there may be a slight offset from a true axial direction (see, for example, FIG. 3 and the twisting of the flange 4 relative to the axis 22).

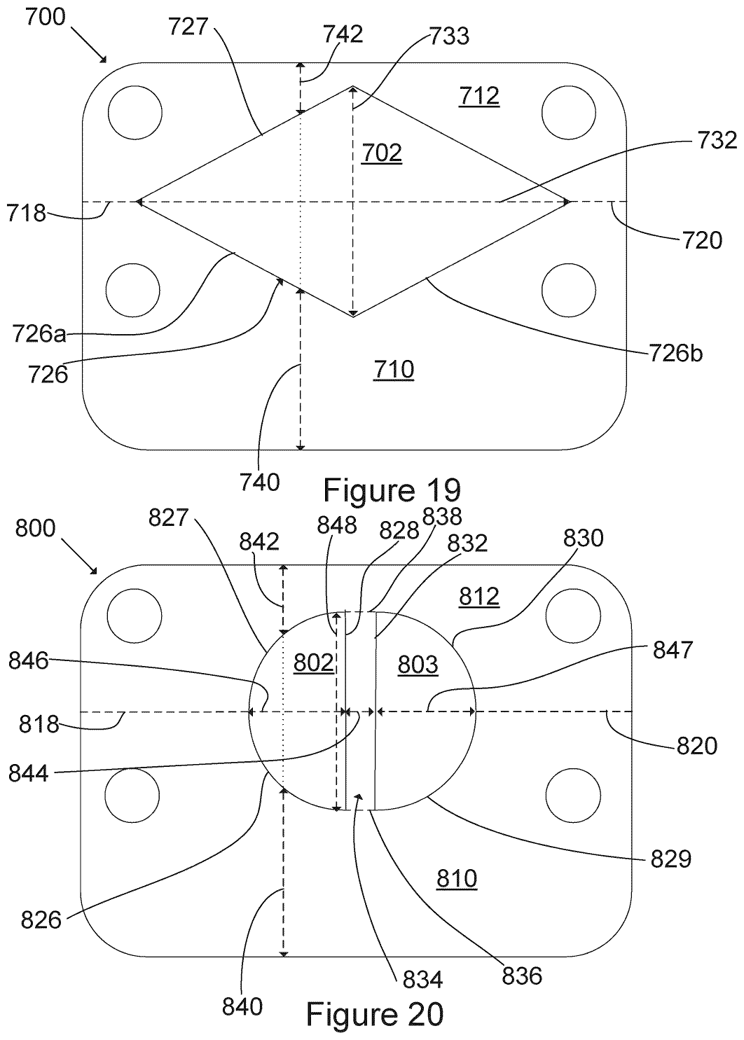

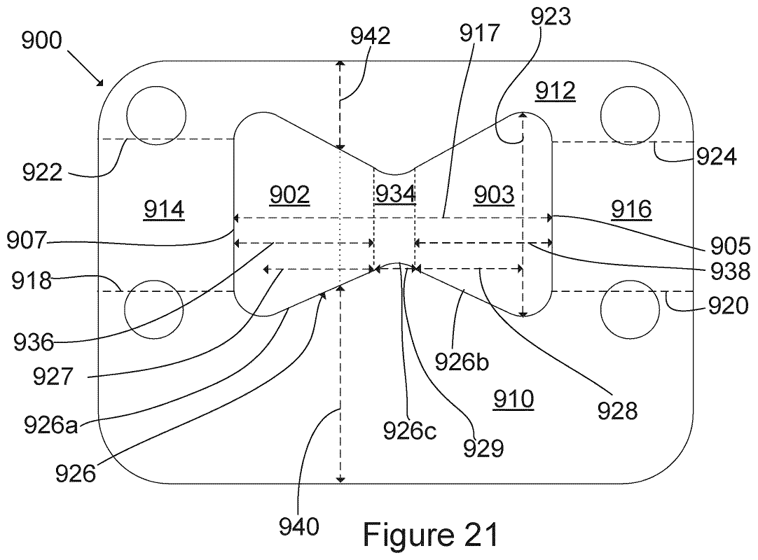

The full extent 70 of the radially inner edge 34 of the first inlet opening 12 may, at least in connection with the illustrated embodiment, otherwise be described as distance, or dimension, of a linear edge (of the first inlet opening 12) parallel to the first major dimension 60 and proximate to the axis 22 (not shown in FIG. 5, but shown in FIG. 4). Described another way, it may refer to a straight line distance along the first major dimension 60 (e.g. in an axial direction) before any corner fillets (e.g. 69, 71) begin to extend from said edge 34. However, and as will be described in connection with at least FIGS. 19 and 21, in other embodiments the radially inner edge may comprise a plurality of linear portions and/or be at least partly arcuate.

Advantageously, where the thickness 64 of the first portion 26 is greater than the thickness 66 of the second portion 28 along at least the full extent 70 of the radially inner edge 34 of the first inlet opening 12, a greater area is provided on the flange 4 which can be placed in fluid communication, during the casting process, with a reservoir of material. Such reservoirs may be a feeder. Described another way, a greater volume, through which material can flow, is present in the flange 4. Molten metal material can thus flow from the reservoir, through the flange/flange cavity, and fill the cavities corresponding to other features of the turbine housing 2. In short, providing the greater thickness as described gives a rise to greater flexibility in the casting process, which can facilitate the incorporation of otherwise difficult features to cast, for example thin walls of the turbine housing 2.

In some embodiments, the thickness 64 of the first portion 26 may be greater than the thickness 66 of the second portion 28 along a full extent of the first inlet opening 12. Said full extent may otherwise be described as the first major dimension as labelled 60 in FIG. 5. A thickness labelled 72 in FIG. 5 indicates the greatest thickness of the first portion 26 at one end of the full extent of the first opening 12. That is to say, when the thicknesses of the first and second portions 26, 28 are compared, with respect to the full extent of the first inlet opening 12 (corresponding with the major dimension 60), the portions 26, 28 are considered to extend to the end of fillets which extend between each of the radially inner and outer edges 34, 36 and adjacent edges 35, 37 which define the third or fourth portions 30, 32 (see also the highlighted areas 92, 94 in FIG. 8). For completeness, a thickness 73 of the second portion 28, which is less than the thickness 72 of the first portion 26, as also schematically indicated in FIG. 5. The full extent of the first inlet opening 12 may be a full axial extent of the first inlet opening 12.

In further embodiments, the thickness 64 of the first portion 62 may be greater than the thickness 66 of the second portion 28 along a full extent 78 of the radially inner edge 41 of the outer edge 16 of the engagement surface 14. Like that described above in connection with the positions of the first and second portions 26, 28 for the full extent of the radially inner edge 34 of the first inlet opening 12, the full extent 78 of the radially inner edge 41 of the outer edge 16 of the engagement surface 14 extends in a generally axial direction between points where fillets, which extend from either end of the radially inner edge 42, begin. The full extent 78 of the radially inner edge 41 of the outer edge 16 of the engagement surface 14 may therefore be a full axial extent of the outer edge 16 of the engagement surface 14. In further embodiments, the first portion 26 may have a thickness which is greater than the thickness of the second portion 28 along an entire extent (optionally axial) of the engagement surface 14.

FIG. 5 also shows the surface 40 which extends between the outer volute surface 38 and the radially inner edge 42 of the outer edge 16 of the engagement surface 14. As previously described, the surface 40 is entirely arcuate in the illustrated embodiment and further incorporates a fillet having a radius of at least around 10 mm, and preferably around 15 mm. Advantageously, the surface 40 acts to blend the outer volute surface 38 with the flange 4 to facilitate the flow of molten metal material, during the casting process, from a reservoir of molten metal material provide proximate the flange 4, specifically the first portion 26 thereof, to the volute 6 and the rest of the turbine housing 2 geometry.

For completeness, FIG. 5 also shows part of the opening 8 which forms part of the outlet portion 50.

Each of first to fourth bores 42, 44, 46. 48 are also visible in FIG. 5. Each of the second to fourth bores 44, 46, 48 extend entirely through the flange 4 (e.g. are through-bores). The first bore 42 is a blind bore insofar as it only extends part way through the flange 4. The first bore 42 may therefore be described as a recess. In other embodiments all bores may be throughbores (optionally threaded throughbores).

For completeness, the aforementioned thicknesses of the various parts of the flange 4 are considered to exclude the bores 42, 44, 46, 48. That is to say, the thicknesses across the engagement surface 14 are treated as if the bores 42, 44, 46, 48 were not present. The thicknesses instead intended refer to a general extent being bound by one or more of the first inlet opening 12 and/or the outer edge 16 of the engagement surface 14.

Turning to FIG. 6, FIG. 6 is identical to FIG. 5 other than being a close-up view of the flange 4 and with the majority of annotations (as labelled in FIG. 5) being excluded. FIG. 6 is included to aid interpretation of FIG. 5 in view of the annotations provided thereon. FIG. 6 does, however, show schematic dividing (or construction) lines 80, 82, 84, 86 which define each of the first to fourth portions 26, 28, 30, 32 of the periphery 18 of the flange 4. For completeness, a first dividing line 80 separates the first and third portions 26, 30. A second dividing line 82 separates the first and fourth portions 26, 32. A third dividing line 84 separates the second and fourth portions 28, 32. A fourth dividing line 86 separates the second and third portions 28, 30. The dividing lines 80, 82, 84, 86 may extend between the outer edge 16 of the engagement surface 14 and shorter, linear ends of the first inlet opening 12. Put another way, the dividing lines may extend from the third and fourth portions 30, 32 at a point where fillets, which connect third and fourth portions 30, 32 to the first and second portions 26, 28, begin.

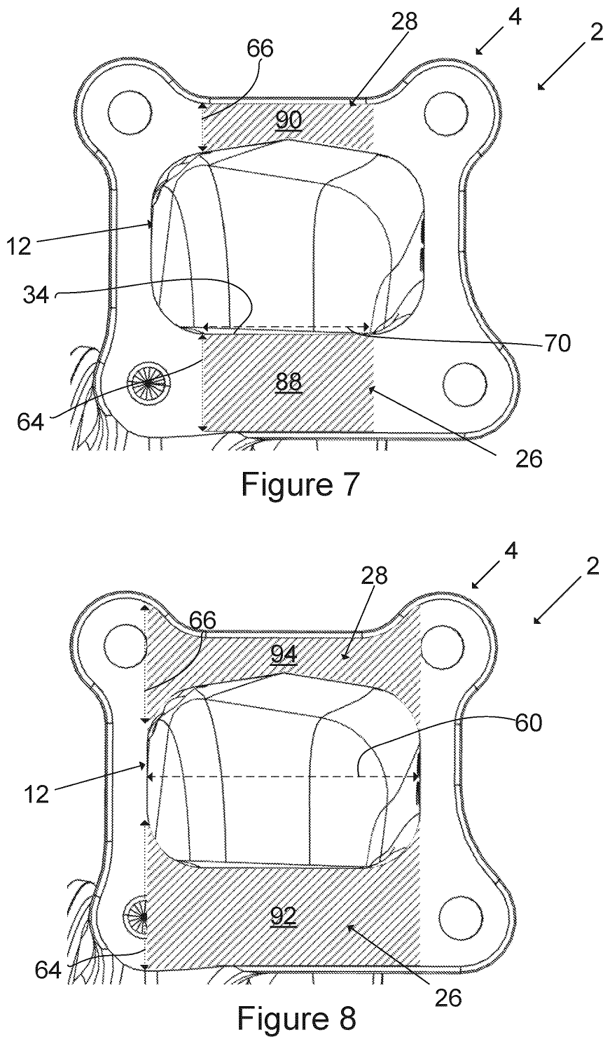

Turning to FIG. 7, another close-up view of the flange 4 is provided. FIG. 7 is annotated to indicate the surface areas 88, 90 defined by a thickness 64, 66 of the respective first and second portions 26. 28 when taken over a full extent 70 of the radially inner edge 34 of the first inlet opening 12. The first surface area 88, indicated by cross hatchings, is the surface area defined by the thickness 64 of the first portion 26 over the full extent 70 of the radially inner edge 34 of the first inlet opening 12. A second surface area 90 is defined by the thickness 66 of the second portion 28 over the full extent 70 of the radially inner edge 34 of the first opening 12. The thickness 64 of the first portion 26 of the periphery is greater than the thickness 66 of the second portion 28 of the periphery along the full extent 70 of the radially inner edge 34 of the first inlet opening 12 in FIG. 7.

Turning to FIG. 8, two new surface areas 92, 94 are indicated. The surface areas 92, 94 correspond to the surface areas defined by the thicknesses 64, 66 of the first and second portions 26, 28 when taken across a full extent 60 of the first inlet opening 12.

The thickness 64 of the first portion 26 of the periphery is greater than the thickness 66 of the second portion 28 of the periphery along the full extent 60 of the first inlet opening 12 in FIG. 8.

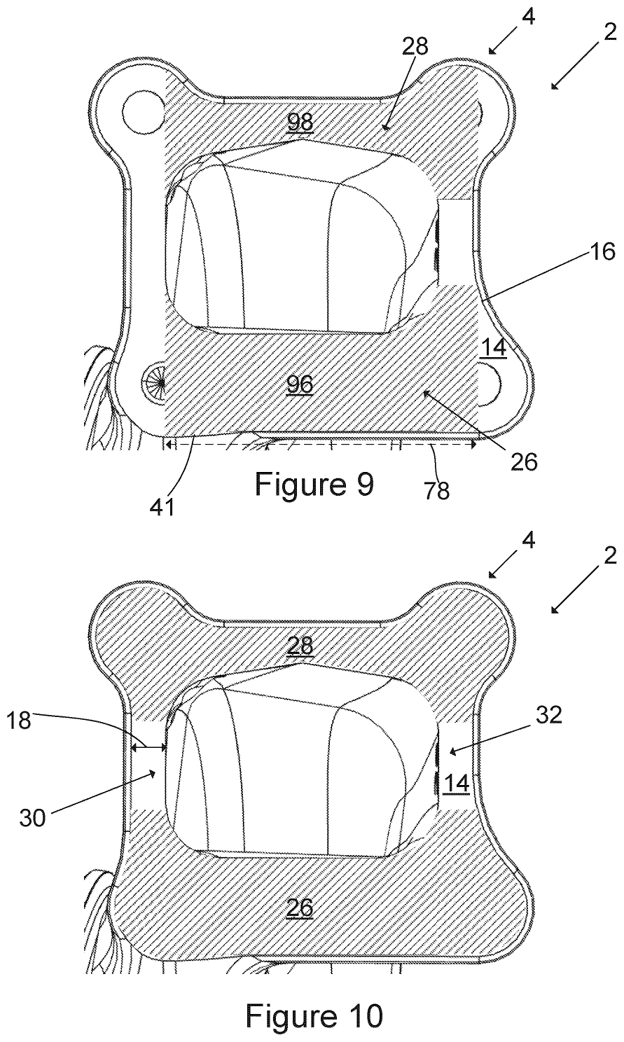

Turning to FIG. 9, two further surface areas 96, 98 are indicated. The surface areas 96, 98 correspond to the surface areas defined by thicknesses of the first and second portions 26, 28 across a full extent 78 of the radially inner edge 41 of the outer edge 16 of the engagement surface 14. The thickness of the first portion 26 of the periphery is greater than the thickness of the second portion 28 of the periphery along a full extent 78 of a radially inner edge 41 of the outer edge 16 of the engagement surface.

FIG. 10 is a further close-up view of the flange 4 with two further surface areas indicated thereon. FIG. 10 shows an entire first portion 26 of the periphery 18, and an entire second portion 28 of the periphery 18. Only the third and fourth portions 30, 32 are not cross-hatched as part of the engagement surface 14 in FIG. 10.

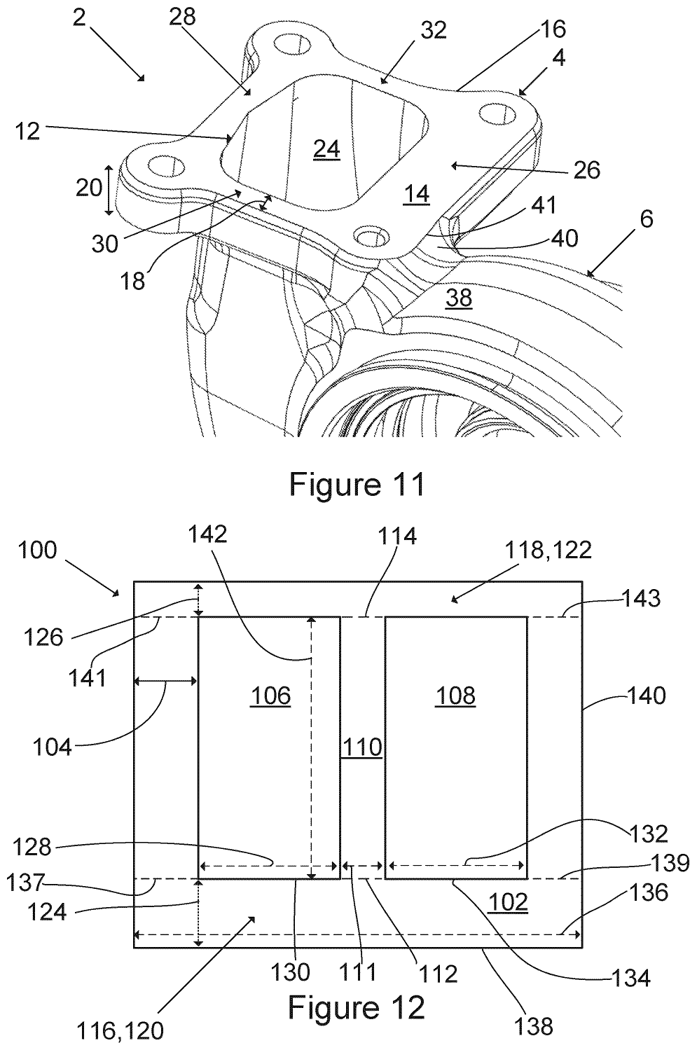

Turning to FIG. 11, a perspective view of the flange 4 and surrounding structure of the turbine housing 2 is provided. The FIG. 11 view further indicates the thickness 20 of the flange 4 and the arcuate surface 40 which extends between the outer volute surface 38 and the radially inner edge 41 of the outer edge 16 of the engagement surface 14. Each of the first, second, third and fourth portions 26, 28, 30, 32 of the periphery 18 are also labelled. The flow passage 28 defined by the first opening 12 is also indicated.

FIG. 12 is a schematic illustration of a flange 100 of a twin-entry turbine housing according to another embodiment. All surrounding structures of the flange 100 are omitted from FIG. 12.

Like the previously described embodiment, the flange 100 comprises an engagement surface 102 defined by a periphery of material 104. The flange 100 defines first and second inlet openings 106, 108. Each of the first and second inlet openings 106, 108 defines a respective flow passage, the passages merging at a nozzle (e.g. point of minimum area) of the turbine housing. The first and second inlet openings 106, 108 are separated by a dividing wall 110. The dividing wall 110 is bound by construction lines 112, 114. An extent of the dividing wall 110 is labelled 111.

First and second portions 116, 118 of the periphery 104 are disposed at radially inner and outer sides 120, 122 of the first and second inlet openings 106, 108 respectively. The first and second portions 116, 118 may otherwise be said to be disposed at radially inner and outer sides of the flange 100 more generally.

A thickness 124 of the first portion 116 is greater than a thickness 126 of the second portion 118 along at least a full extent 128 of a radially inner edge 130 of the first inlet opening 106.

The thickness of the first portion 116 may be greater than the thickness 126 of the second portion 118 along a full extent of both the first and second inlet openings 106, 108. The full extent of both the first and second inlet openings 106, 108 is the sum of the full extents 128, 132 of the radially inner edges 130, 134 of the first and second inlet openings 106, 108 (i.e. excluding the dividing wall 110).

The thickness of the first portion 116 may be greater than the thickness 126 of the second portion 118 along a full extent 136 of the radially inner edge 138 of the outer edge 140 of the engagement surface 102 (excluding the dividing wall 110). For completeness, the first portion 116 is bound by construction lines 137, 139 (and 112). The second portion 118 is bound by construction lines 141, 143 (and 114).

Taking the first inlet opening 106 as an example, in the illustrated embodiment the full extent 128 of the radially inner edge 130 of the first inlet opening 106 defines a first major dimension of the opening 106. A second major dimension is labelled 142. Unlike the previous embodiment, for a twin-entry turbine housing flange the first major dimension (e.g. 106) is smaller than the second major dimension 142. Put another way, it is the second major dimension 142 which defines a longer side of the rectangular inlet opening 106. The same applies for the second inlet opening 108.

All of the advantages described in connection with the single-entry turbine housing (e.g. a turbine housing having a single inlet opening) apply equally to a twin-entry turbine housing (e.g. a turbine housing having more than one inlet opening) in accordance with the disclosure.

As mentioned throughout this document, the present disclosure, concerning relative thicknesses of the first and second portions, advantageously facilitates the casting of turbine housings for a greater range of features. Providing the thicker first portion. proximate the axis, means that a reservoir of molten metal material, such as a feeder or riser, can extend from the first portion, or specifically from a corresponding mould cavity thereof, during casting. This provides a further flow path for molten metal material to flow through the mould during the casting process. This is particularly advantageous for thin-walled turbine housings e.g. turbine housings having a volute with a wall thickness of less than around 5 mm on the side walls and/or less than around 6 mm around a circumferential outer surface of the walls. The incorporation of the comparatively thicker first portion means that the wall thickness of the turbine housing can be reduced without there being resulting detrimental effects during the casting process. Such detrimental effects could otherwise lead to the ‘freezing off’ of certain sections of the mould, owing to the comparatively thinner walls solidifying faster than comparatively thicker, or bulkier, parts of the turbine housing.

Thin-walled turbine housings are desirable for the reason that, on engine start-up, a thin-walled turbine housing will generally heat up to an operating temperature faster than a thicker-walled turbine housing. This means that there is a reduced heat transfer from the exhaust gas to the turbine housing at a faster rate than there would otherwise be. Described another way, the turbine housing reaches a saturation temperature, more quickly, at which temperature the heat transfer from the exhaust gas to the turbine housing reduces in magnitude. This, in turn, means that a greater proportion of heat is transferred from the exhaust gas to exhaust aftertreatment devices, such as SCR devices, downstream of the turbine. The greater heat transfer to the downstream aftertreatment devices facilitates the faster activation of such aftertreatment devices on engine start up. Emissions can therefore be reduced as a result.

FIG. 13 is a perspective cross section view of the turbine housing 2.

FIG. 13 shows various features including the flange 4, volute 8 and the outlet opening 8. The outlet portion 50, including diffuser 54, are also shown. The nozzle 52 is also indicated, along with outer volute surface 38. The axis 22 is also labelled.

A thickness of first and second volute sidewalls 7, 9 is labelled 11, 13. A thickness 15 of a circumferentially outer wall surface 17 is also indicated. The thicknesses 11, 13 are less than around 5 mm, and the thickness 15 is less than around 6 mm, the turbine housing 2 thus being a thin-walled turbine housing. Then thickness 15 may be greater than the thicknesses 7 and/or 9 to facilitate containment of a turbine wheel (in case of a blade-off scenario). The thickness 15 may differ from the thicknesses 7 and/or 9.

FIG. 13 indicates that the (thicker) first portion 26 is provided proximate the axis 22. This means that any molten metal material ‘fed’ through the first portion 26 (during the casting process) has less distance to travel to reach a main bulk of the material in the turbine housing 2. As mentioned above, this i) reduces the risk that any part of the mould become ‘frozen off’ due to solidification of the molten metal material; and ii) means that the wall thickness of the turbine housing can be advantageously reduced as a result. FIG. 13 also illustrates that the turbine housing 2 is a monolithic component (e.g. a single-piece body). Each of the flange 4, volute 6 and outlet portion 50 are thus integral with one another.

FIG. 14 is a schematic illustration of the turbine housing 2, shown in FIG. 13, further including features of relevance during the casting process (e.g. the process used to manufacture the turbine housing 2).

In a first method step, molten metal material (e.g. molten iron) is poured into a mould (the mould being omitted from FIG. 14) via a pouring cup. A filter, such as a ceramic filter, may be provided downstream of the pouring cup to filter debris, such as dirt and slag, from the molten metal material (before it enters the mould). The aforementioned features are omitted from FIG. 13.

The molten metal material flows through branches, which may be referred to as ingates, to enter the mould (or mould cavity). Multiple branches may be provided (e.g. between two and four per mould). The molten metal material thus fills the mould.

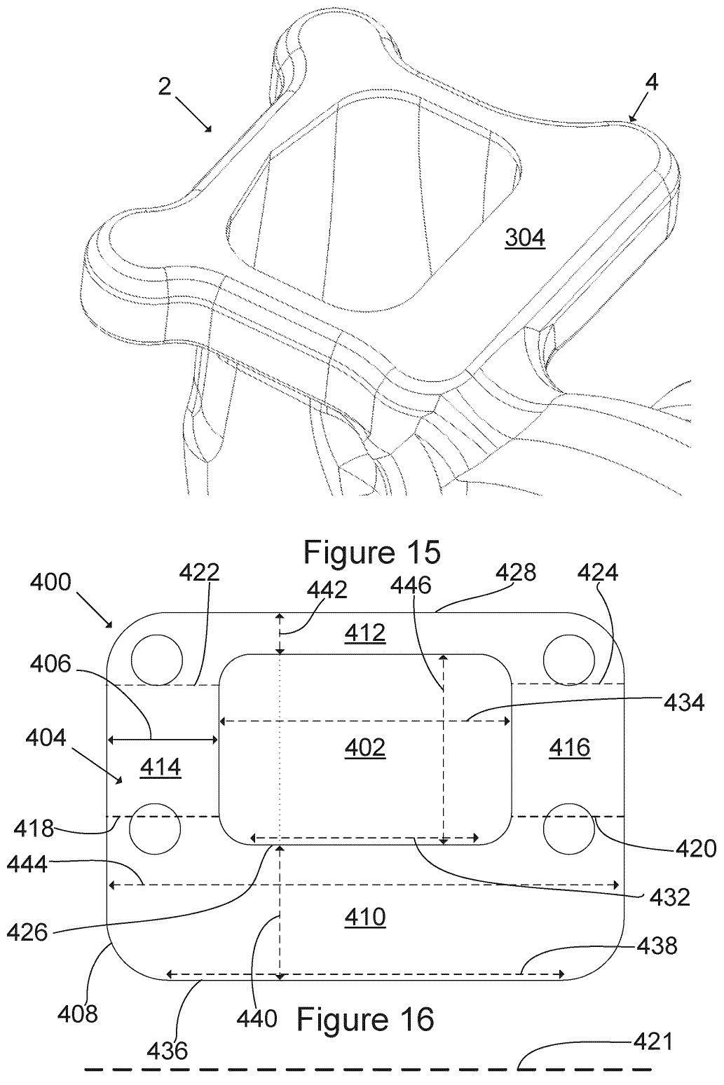

A reservoir 302, which may be referred to as a feeder, is also filled with the molten metal material. The reservoir 302 is filled with molten metal material via a feeder pad 304 as part of the ‘main’ pouring of molten metal material in to the mould. The reservoir 302 is in fluid communication with the mould cavity which defines the turbine housing 2 via a feeder pad 304 (see also FIG. 15). It is the feeder pad 304 which, after machining, defines the first portion 26 of the flange 4 (see FIG. 5). The reservoir 302 refers to a component which is not the main source of the molten metal material (i.e. the reservoir 302 is not the pouring cup/associated branch into which molten metal material is introduced into the mould).

Once the mould is filled with molten metal material, some of the molten metal material rises up, through the mould, out of risers 306, 308.

The reservoir 302 provides the casting with molten metal material as it cools and shrinks within the mould. As turbine housings typically have large variations in wall thicknesses (e.g. between around 5 mm and around 40 mm), the various parts of the casting cool down at different rates. Comparatively thinner sections solidify before comparatively thicker sections. The comparatively thicker sections of a turbine housing are typically located in a centre of the part (see portions labelled 310, 312). Without a reservoir 302 of material, said thicker parts 310, 312 may be ‘frozen off’ by virtue of the comparatively thinner surrounding walls solidifying before the thicker parts 310, 312. The reservoir 302 is thus positioned such that the feeder pad 304 provides a molten connection (or fluid pathway) between the reservoir 302 and the thicker parts 310, 312. This allows molten metal material from the reservoir 302 to replenish material in the shrinking casting in the thicker parts 310, 312. Centreline shrinkage defects can thus be avoided.

The surface 40, extending between the flange 4 and the outer volute surface 38, facilitates the flow of material from the reservoir 302 to the rest of the turbine housing 2.

By providing the feeder pad 304 at a first portion of the periphery of the flange 4, the need to provide a feeder pad at an outer volute surface may be avoided. As a result, the volute wall thickness can be reduced, and an otherwise somewhat bulky geometry, which would otherwise extend from the volute surface (the remains of the feeder pad) can also be avoided. Said bulky geometry could otherwise worsen the thermomechanical fatigue performance of the turbine housing due to the variation of the thicknesses in the cast turbine housing. Furthermore, the feeder pad 304, and reservoir 302, are also thus located proximate the thicker parts 310, 312 of the casting (in comparison to, for example, locating the feeder pad 304 and reservoir 302 at the second portion of the periphery).

The smaller a runner system is the cheaper the manufacturing process is (owing to being able to fit more parts in a single mould). For completeness, a reservoir 302 may not be needed if the turbine housing 2 had a uniform thickness.

The risers 306, 308 may be located at the highest points in the mould. The reservoir 302 may be located between both below and above the highest point of the mould. The risers 306, 308 allow gas to escape from within the mould. The reservoir 302 may also provide this functionality, but primarily provides a supply of molten metal material to the casting (to compensate for shrinkage as the casting cools).

FIG. 15 is a perspective view of the flange 4 of the turbine housing 2 after casting. FIG. 15 shows the flange 4 before the feeder pad 304 is machined off of the flange 4. After the feeder pad 304 has been machined off (e.g. by a milling process), the flange 4 as shown in FIG. 11 remains. FIG. 15 shows the flange 4 in an ‘as supplied’ geometric form (e.g. as received from a foundry).

For completeness, some further flange geometries will now be described in connection with FIGS. 16 onwards.

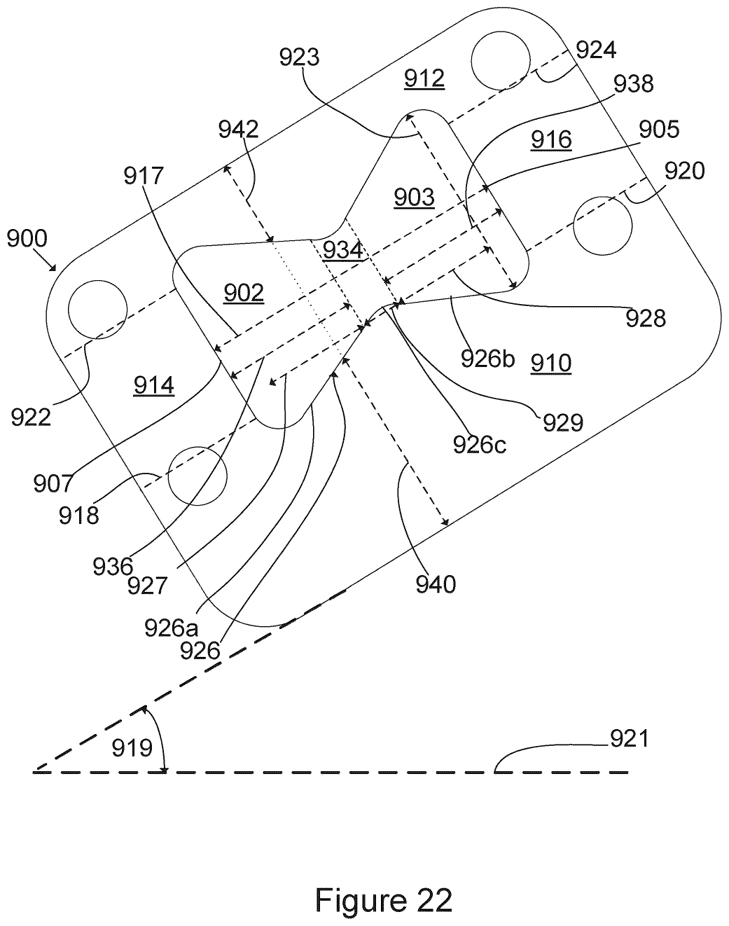

FIG. 16 is a schematic close-up view of a flange 400 according to another embodiment. The flange 400 is shown in isolation of the rest of a turbine housing of which the flange 400 forms part. A nominal axis 421 is also included for reference (although, as indicated and described in connection with FIG. 22, any of the following, or preceding, flanges may be provided at an angle of up to around 45° to a ‘true’ axial direction).

The flange 400 defines a first inlet opening 402 in an engagement surface 404. The first inlet opening 402 is the only inlet opening 402 defined by the flange 400. The first inlet opening 402 is generally rectangular in that it is defined by two pairs of generally parallel sides (with corner fillets extending therebetween).

As described in connection with earlier embodiments, the engagement surface 404 is defined by a periphery 406 of material which extends between the first inlet opening 402 and an outer edge 408 of the engagement surface 404.

A first portion 410 of the periphery 406 is provided at a radially inner side of the first inlet opening 402. A second portion 410 of the periphery 406 is provided at a radially outer side of the first inlet opening 402. Third and fourth portions 414, 416 of the periphery 406 extend between the first and second portions 410, 412 and are bound by construction lines 418, 420, 422, 424.

A radially inner edge 426 of the first inlet opening 402 is linear. Similarly, the radially outer edge 428 of the first inlet opening 402 is also linear. A full extent of the radially inner edge 426 is labelled 432. A full extent of the first inlet opening 402 is labelled 434. A full extent of a radially inner edge 436 of the outer edge 408 of the engagement surface is labelled 438.

The line 434 also indicates a first major dimension of the first inlet opening 402. Line 446 indicates a second major dimension of the first inlet opening 402.

A thickness 440 of the first portion 410 of the periphery 406 is greater than the thickness 442 of the second portion 412 of the periphery 406 along: i) the full extent 432 of the radially inner edge 426 of the first inlet opening 402; ii) the full extent 434 of the first inlet opening 402; iii) the full extent 438 of the radially inner edge 436 of the radially outer edge 408 of the engagement surface 404; and iv) a full extent 444 of the engagement surface 404. As described elsewhere, each of the ‘extents’ referred to above may be axial extents.

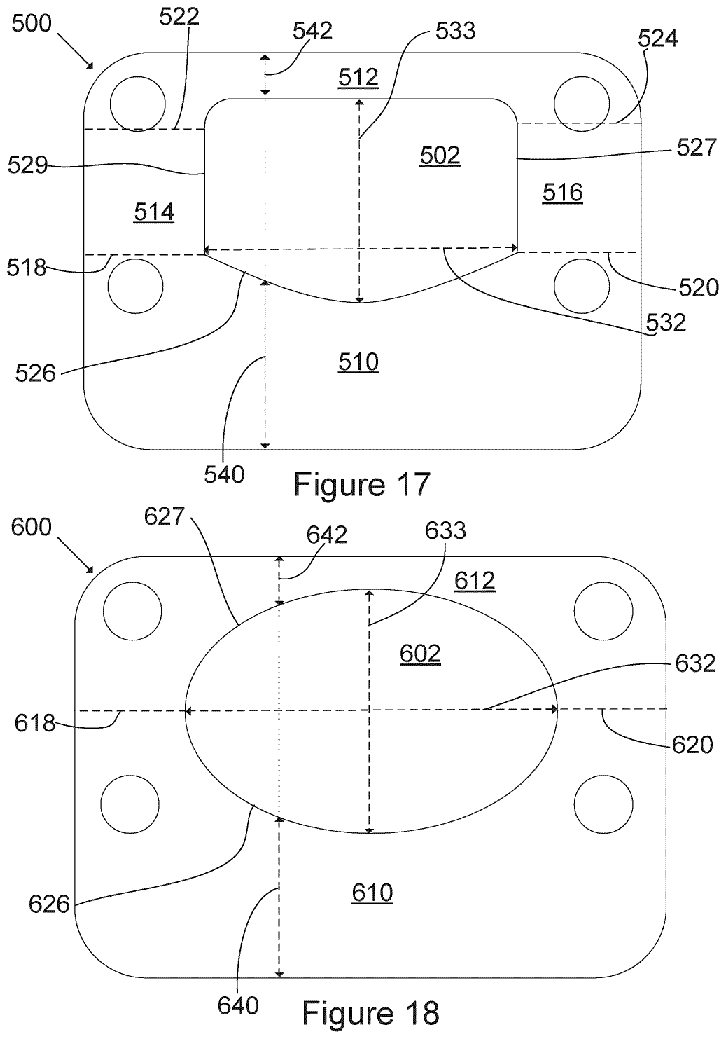

FIG. 17 shows a flange 500 according to a further embodiment. The flange 500 shares many features in common with the flange 400, and so only the differences will be described in detail.

The flange 500 defines a first inlet opening 502 in an engagement surface thereof. A radially inner edge 526 of the first inlet opening 502 is arcuate, specifically entirely arcuate. The radially inner edge 526 extends between front and rear edges 527, 529 of the first inlet opening 529. A full extent 532 of the radially inner edge 526 is indicated in FIG. 17. First, second, third and fourth portions 510, 512, 514, 516 of the periphery are also labelled, separated by construction lines 518, 520, 522, 524.

A full extent 532 of the radially inner edge 526 is equal to a full extent of the first inlet opening 502 owing to the lack of corner fillets between the radially inner edge 526 and the front and rear edges 527, 529 respectively. The full extent 532 is equivalent to a first major dimension of the first inlet opening 502. A second major dimension of the first inlet opening 502 is labelled 533.

A thickness 540 of the first portion 510 is greater than a thickness 542 of the second portion 512 along a full extent 532 of the radially inner edge 526 of the first inlet opening 502 (which is equal to a full extent 532 of the first inlet opening 502) and full extents of: i) a radially inner edge of an outer edge of the engagement surface; and ii) the engagement surface.

FIG. 18 shows a flange 600 according to a further embodiment. The flange 600 shares many features in common with the flanges 400, 500, and so only the differences will be described in detail.

A first inlet opening 602 is elliptical. That is to say, an outer edge of the first inlet opening 602 is entirely arcuate. As there are no discernible front and rear edges of the first inlet opening 602 (i.e. 527, 529 in FIG. 17), an engagement surface is considered to be defined by only first and second portions 610, 612 of a periphery of material. The first and second portions 610, 612 are located at radially inner and outer sides of the first inlet opening 602 respectively. The first and second portions 610, 612 are split about a (lengthways) midpoint of the first inlet opening 602 as indicated by construction lines 618, 620. Similarly, the first inlet opening 602 is defined by only a radially inner edge 626 and a radially outer edge 627 as divided about the construction lines 618, 620 (or a [lengthways] midpoint of the first inlet opening 602).

A full extent 632 of the radially inner edge 626 of the first inlet opening 602 is equal to a first major dimension of the first inlet opening 602. A second major dimension is indicated 633.

A thickness 640 of the first portion 610 is greater than a thickness 642 of the second portion 612 along the full extent 632 of the radially inner edge 626 of the first inlet opening 602 (which is equal to a full extent 632 of the first inlet opening 602 in FIG. 18) and a full extent of: i) a radially inner edge of an outer edge of the engagement surface; and ii) the engagement surface.

FIG. 19 shows a flange 700 according to a further embodiment. The flange 600 shares many features in common with the flanges 400, 500, 600 and so only the differences will be described in detail.

A first inlet opening 702 is diamond-shaped. A radially inner edge 726 of the first inlet opening 702 thus comprises two linear portions 726a, 726b. Similarly, a radially outer edge 727 of the first inlet opening 702 comprises two linear portions. A midpoint of the first inlet opening 702 is defined where the radially inner edge 726 meets the radially outer edge 727, as indicated by construction lines 718, 720. The flange 700 comprises only first and second portions 710, 712 of the periphery of material (like FIG. 18), as bound by the construction lines 718, 720.

A thickness 740 of the first portion 710 is greater than a thickness 742 of the second portion 712 along a full extent 732 of the radially inner edge 726 of the first inlet opening 702 (which is equal to a full extent 732 of the first inlet opening 702 in FIG. 19) and a full extent of: i) a radially inner edge of an outer edge of the engagement surface; and ii) the engagement surface.

A second major dimension of the first inlet opening 702 is labelled 733.

FIG. 20 shows a flange 800 according to a further embodiment. The flange 800 shares many features in common with the preceding figures, and so only the differences will be described in detail.

The flange 800 forms part of a twin-entry turbine housing owing to the presence of first and second inlet openings 802, 803. The first and second inlet openings 802, 803 are both D-shaped. The first and second inlet openings 802, 803 generally mirror one another so as to form a pair of openings.

A radially inner edge 826 of the first inlet opening 802 extends radially inwards from a midpoint of the opening 802 as defined by construction line 818. A radially outer edge 827 of the first inlet opening 802 extends radially outwardly from the midpoint of the opening 802. Ends of the radially inner and outer edges 826, 827 meet a linear portion 828 of the inlet opening 802.

A radially inner edge 829 of the second inlet opening 803 extends radially inwards from a midpoint of the opening 803 as defined by construction line 820. A radially outer edge 830 of the second inlet opening 803 extends radially outwardly from the midpoint of the opening 803. Ends of the radially inner and outer edges 829, 830 meet a linear portion 832 of the inlet opening 802.

Like that described in connection with FIG. 12, a dividing wall 834 extends between the first and second inlet openings 802, 803. Construction lines 836, 838, which extend between the linear portions 828, 832 of the inlet openings 802, 803, define outer ends of the dividing wall 834. An extent of the dividing wall 834 is labelled 844.

Extents of each of the first and second inlet openings 802, 803 are labelled 846, 847. Said extents 846, 847 are equal to first major dimensions of the first inlet openings 802, 803. Second major dimensions of the first and second inlet openings 802, 803 are labelled 848. Although a single dimension is indicated, owing to the mirrored nature of the inlet openings 802, 803, the line 848 is indicative of the second major dimension for both openings 802, 803. In this embodiment, the second major dimension 848 is larger than the first major dimensions 846, 847.

A thickness 840 of the first portion 810 is greater than a thickness 842 of the second portion 812 along: i) a full extent 846 of the radially inner edge 826 of the first inlet opening 802 (which is equal to a full extent 846 of the first inlet opening 802 in FIG. 20); ii) a full extent 846, 847 of the radially inner edges 826, 829 of the first and second inlet openings 802, 803; iii) a full extent of a radially inner edge of an outer edge of the engagement surface; and iv) a full extent of the engagement surface. Any of the above extents may be axial extents. The above extents are intended to exclude the extent 844 of the dividing wall 834.

FIG. 21 shows a flange 900 according to a further embodiment. The flange 900 shares many features in common with the preceding figures, and so only the differences will be described in detail.

The flange 900 may have a single inlet opening 902 of the indicated butterfly geometry. Alternatively, the flange 900 may have first and second inlet openings 902, 903 separated by a dividing wall 934. Both arrangements will be described below.

In either arrangement, first and second portions 910, 912 of a periphery of material are provided at radially inner and outer sides of the first inlet opening 902. Third and fourth portions 914, 916 extend therebetween. Construction lines 918, 920, 922, 924 define the separate portions 910, 912, 914, 916.

For a single inlet opening arrangement, there is no dividing wall 934 and the opening extends around an entire perimeter as defined by the first and second inlet openings 902, 903 indicated in FIG. 20. A radially inner edge 926 thus comprises two linear portions 926a, 926b and an arcuate portion 926c therebetween. Like previous embodiments, the radially inner edge 926 is considered to exclude the corner fillets which lead into front and rear edges 905, 907 of the opening. A full extent of the radially inner edge 926 of a single inlet opening embodiment is thus equal to the sum of the extents 927, 928, 929 of each of the linear portions 926a, 926b and the arcuate portion 926c in FIG. 20.

For a single inlet opening arrangement, a major dimension, or full extent, of the inlet opening is labelled 917. A second major dimension is labelled 923. The second major dimension 923 is the same irrespective of whether the flange 900 comprises a single inlet opening or two inlet openings.

For a twin inlet opening arrangement, having (separate) first and second inlet openings 902, 903, there is a dividing wall 934 which separates the openings. Linear portions 926a, 926b thus define radially inner edges of each of the first and second inlet openings respectively. A full extent of the radially inner edge of the first inlet opening 902 is thus equal to the extent 927 of the linear portion 926a. A full extent of the radially inner edge of the first and second inlet openings 902, 902 is equal to the extents 927 and 928 of the linear portions 926a, 926b (i.e. excluding an extent 926c of the dividing wall 934).

Full extents 936, 938 of the first and second inlet openings 903, 903 are labelled in FIG. 21. For a single inlet opening arrangement, a full extent of the inlet opening is equal to the sum of the extents 936, 938 and the extent 939 of the arcuate portion 926c/dividing wall 934 (also shown by extent 917).

For an embodiment having separate first and second openings 902, 903: a thickness 940 of the first portion 910 is greater than a thickness 942 of the second portion 912 along: i) a full extent 927 of the radially inner edge (linear portion 926a) of the first inlet opening 902; ii) a full extent 936 of the first opening 902; iii) a full extent 927, 928 of the radially inner edges (linear portions 926a, 926b) of the first and second inlet openings 902, 903; and iv) a full extent 936, 938 of the first and second inlet openings 902, 903.

For an embodiment having a single opening with the geometry of combined inlet openings 902, 903: a thickness 940 of the first portion 910 is greater than a thickness 942 of the second portion 912 along: i) a full extent 927, 928, 929 of the radially inner edge 926 of the inlet opening; ii) a full extent 936, 938, 929 (or 917) of the inlet opening.

For either embodiment, a thickness 940 of the first portion 910 is greater than a thickness 942 of the second portion 912 along: i) a full extent of a radially inner edge of an outer edge of the engagement surface; and ii) a full extent of the engagement surface. Any of the above extents may be axial extents. The extents exclude an extent 929 of the dividing wall 934.

FIG. 22 shows the flange 900 of FIG. 21 inclined at an angle 919 to a ‘true’ axial direction as defined by axis 921. The angle 919 is around 30° in FIG. 22, but may be anywhere up to around 45°. The flange 900 is rotated in a counterclockwise direction, but in other embodiments may be rotated in a clockwise direction. The flange 900 may also be rotated out of a plane of the page (e.g. as indicated in FIG. 4).

FIG. 22 is included to indicate that, even with an incline or rotation of the flange 900 relative to a ‘true’ axial direction, the first portion 910 of the periphery is still considered to be provided at a radially inner side of the inlet opening 902. The various extents indicated on the flange 900 therefore need not be collinear with the axis 921 (although, in some embodiments, this may be the case). Further, major dimensions (e.g. 923 and 917 or 936/938) of the opening(s) may also be inclined, or rotated, at an angle relative to a ‘true’ axial direction.

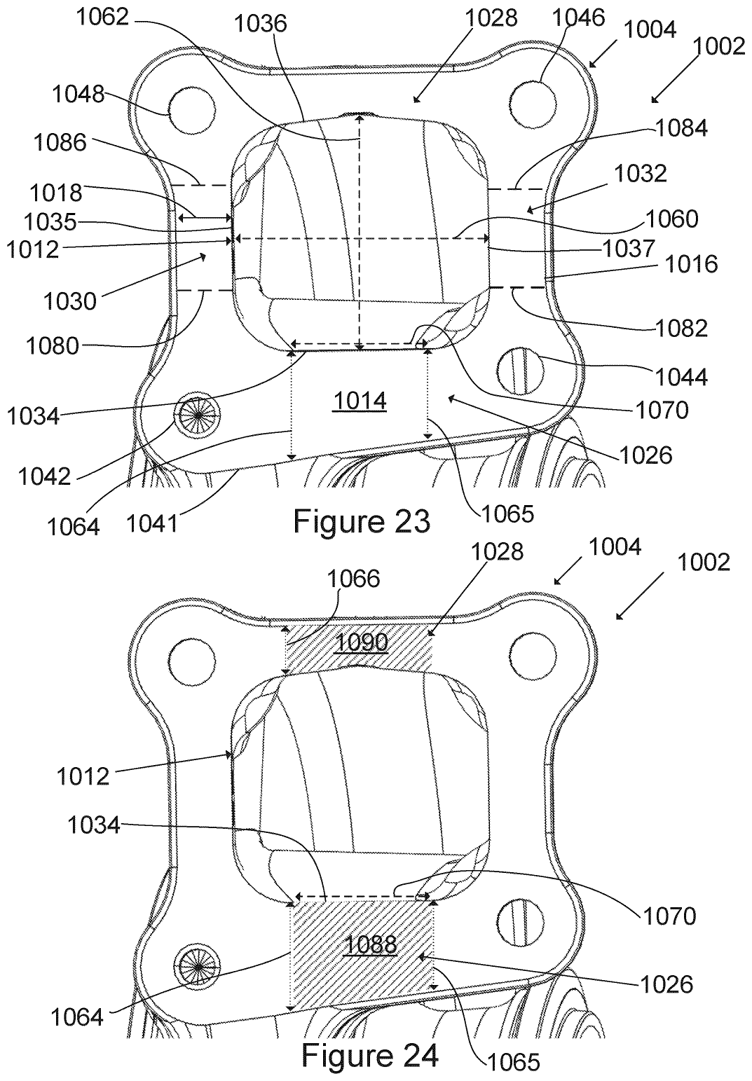

Turning to FIG. 23, a close-up view of a flange 1004 forming part of a turbine housing 1002 according to another embodiment is provided. Of note, the turbine housing 1002, and so flange 1004, shares many features in common with the previous embodiments (and particularly those shown in FIGS. 2 to 15), and so only the differences will be described here in detail.

Briefly, as previously described in connection with the earlier embodiments, the flange 1004 comprises an engagement surface 1014 defined by a periphery 1018 of material. The periphery 1018 extends around a first inlet opening 1012 to an outer edge 1016 of the engagement surface 1014.

Periphery 1018 comprises a first portion 1026, provided at a radially inner side of the first inlet opening 1012 (e.g. adjacent a radially inner edge 1034 of the first inlet opening 1012). The periphery 1018 further comprises a second portion 1028 provided at a radially outer side of the first inlet opening 12 (e.g. adjacent a radially outer edge 1036 of the first inlet opening 1012). Third and fourth portions 1030, 1032 of the periphery 1018 extend between the first and second portions 1026, 1028. Schematic dividing lines 1080, 1082, 1084, 1086 define each of the first to fourth portions 1026, 1028, 1030, 1032 of the periphery 1018 of the flange 1004.

The first and second portions 1026, 1028 may be described as being a pair of axially disposed sides. This is owing to the fact that the first and second portions 1026, 1028 generally extend in an axial direction (albeit with the first portion 1026 being generally trapezoidal). Put another way, a major dimension of the first and second portions 1026, 1028 is generally in an axial direction. The third and fourth portions 1030, 1032 may be described as a pair of radially disposed sides owing to the third and fourth portions 1030, 1032 having major dimensions in a generally radial direction.

The engagement surface 1014 of the flange 1004 also comprises a plurality of bores 1042, 1044, 1046, 1048. The bores 1042, 1044, 1046, 1048 are generally disposed at a respective corner of the flange 1004 and are configured to receive a fastener.

The first inlet opening 1012 has first and second major dimensions 1060, 1062. The first and second major dimensions 1060, 1062 define the greatest separation of the two pairs of generally parallel sides that define the first inlet opening 1012.

As mentioned above, the flange 1004 shares many features in common with the earlier embodiments, although a notable difference is the shape of the first portion 1026. In particular, radially inner edge 1041 of the outer edge 1016 of the engagement surface 1014 is not parallel to the radially inner edge 34 of the first inlet opening 1012. Instead, the inner edge 1041 of the outer edge 1016 is generally inclined relative to the radially inner edge 1034 of the first inlet opening 12. As a result, the overall flange 1004 may be described as generally trapezoidal in comparison to a generally rectangular geometry as in the previous embodiments. Similarly, the first portion 1026, at least along the full extent 1070 of the radially inner edge 1034 of the first inlet opening 1012. may be described as generally trapezoidal.

A thickness 1064 (at one end of the radially inner edge 1034 of the first inlet opening 1012) of the first portion 1026 is greater than a thickness 1065 (at the other end of the radially inner edge 1034) of the first portion 1026. Providing further detail, a distance between the radially inner edge 1034 of the first inlet opening 1012 and a corresponding point on the radially inner edge 1041 of the outer edge 1016 of the engagement surface 1014, in a direction parallel to the second major dimension 1062, is greater proximate an axially rear edge 35 of the first inlet opening 1012 than an axially front edge 1037 of the first inlet opening 1012.

The thickness 1064, 1065 of the first portion 1026 decreases continuously, in a linear manner (e.g. tapers), along the full extent 1070 of the radially inner edge 1034 of the first inlet opening 1012. The first portion 1026 is therefore trapezoidal in this region, owing to it being defined by the thicknesses 1064, 1065 (which are parallel to one another) as one pair of sides, and the combination of the extent 1070 and (inclined) radially inner edge 1041 of the outer edge 1016 of the engagement surface 1014 as the other pair of sides.

Advantageously, the variable thickness of the first portion 1026 of the periphery 1018 of material can be used to improve the casting process in the manufacture the turbine housing 1002, and improve the flexibility of other aspects of the design of the turbine housing 1002. For example, with brief reference to FIG. 14, the reservoir 302, which may be referred to as a feeder, of molten metal material can be placed in fluid communication with the first portion 1026 where the thickness 1064 of the first portion 1026 is comparatively larger. Given that the higher thickness facilitates a greater volume of molten metal material flowing therethrough, and that comparatively higher volume regions will be the slowest of the molten metal material to cool, this reduces the risk of molten metal material cooling unduly quickly and “freezing” other regions of the turbine housing (e.g. solidifying too quickly and preventing molten metal material reaching other parts of the mould). This is of particular importance for the reservoir 302, which functions to provide a supply of molten metal material to the mould as the other molten metal material cools and contracts. That is to say, it is desirable that the entry point of the reservoir 302 to the turbine housing mould (e.g. through the first portion) be one of the last, if not the last, part of the newly-cast turbine housing to cool and solidify.

Turning now to FIG. 24, another close-up view of the flange 10004 is provided. FIG. 24 is annotated to indicate the surface areas 1088, 1090 defined by thicknesses 1064, 1066 of the first and second portions 1026, 1028 respectively over a full extent 1070 of the radially inner edge 1034 of the first inlet opening 1012. As such, the thickness 1064 of the first portion 1026 of the periphery is greater than a corresponding thickness 1066 of the second portion 1028 of the periphery along the full extent 1070 of the radially inner edge 1034 of the first inlet opening 1012.

In the illustrated embodiment, the thickness 1064 of the first portion 1026 of the periphery 1018 is around 25 mm. In other embodiments the thickness 1064 may be between around 20 mm and around 30 mm, more preferably between around 24 mm and around 26 mm. In the illustrated embodiment, the thickness 1065 of the first portion 1026 of the periphery 1018 is around 21 mm. In other embodiments the thickness 1065 may be between around 15 mm and around 25 mm, more preferably between around 20 mm and around 22 mm. In the illustrated embodiment, the thickness 1066 of the second portion 1028 of is around 12 mm. In other embodiments the thickness 1066 may be between around 5 mm and around 15 mm, more preferably between around 9 mm and around 13 mm. A minimum thickness of the second portion 1028 of the periphery 1018 is preferably at least around 5 mm, more preferably at least around 8 mm.

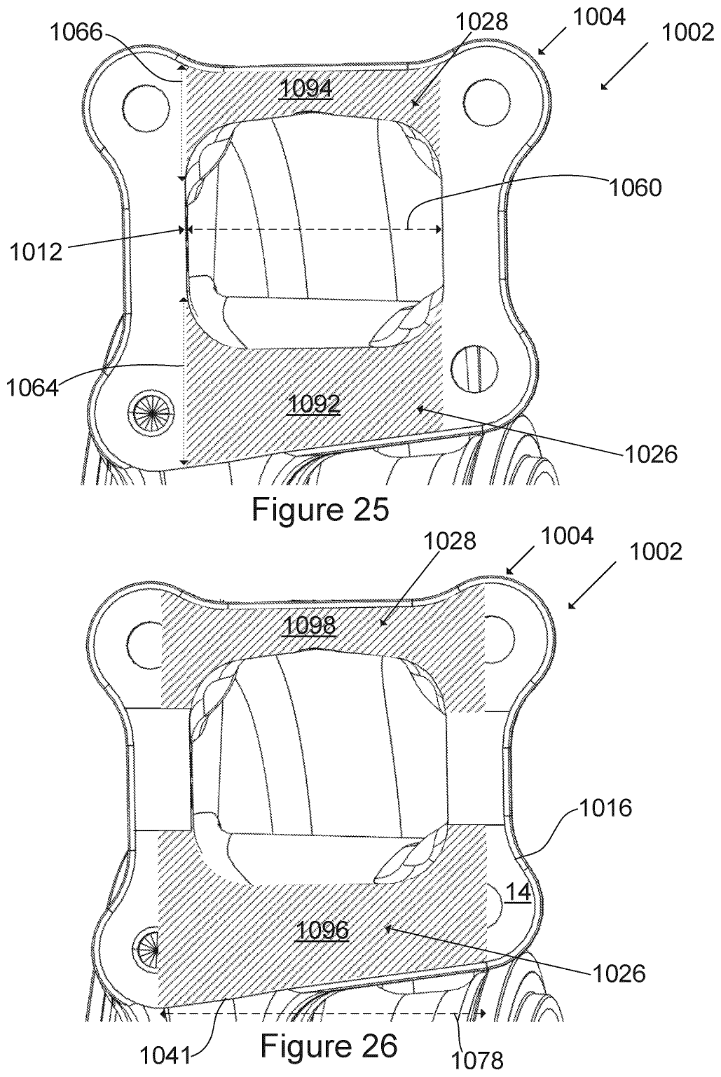

Turning to FIG. 25, surface areas 1092, 1094 as defined by thicknesses 1064, 1066 of the first and second portions 1026, 1028 respectively when taken over a full extent 1060 of the first inlet opening 1012 are indicated. The thickness 1064 of the first portion 1026 of the periphery is greater than a corresponding thickness 1066 of the second portion 1028 of the periphery along an entire extent 1060 of the first inlet opening 1012 (e.g. in a direction corresponding to a first major dimension of the first inlet opening 1012).

Turning to FIG. 26, indicated surface areas 1096, 1098 correspond to regions of the first and second portions 1026, 1028 along a full extent 1078 of the radially inner edge 1041 of the outer edge 1016. The thickness of the first portion 1026 is greater than a corresponding thickness of the second portion 1028 along the full extent 1078 of the radially inner edge 1041 of the outer edge 1016 of the engagement surface. The thickness 1064 of the first portion 1026 of the periphery is greater than a corresponding thickness 1066 of the second portion 1028 of the periphery along an entire extent 1060 of the first inlet opening 1012 (e.g. in a direction corresponding to a first major dimension of the first inlet opening 1012).

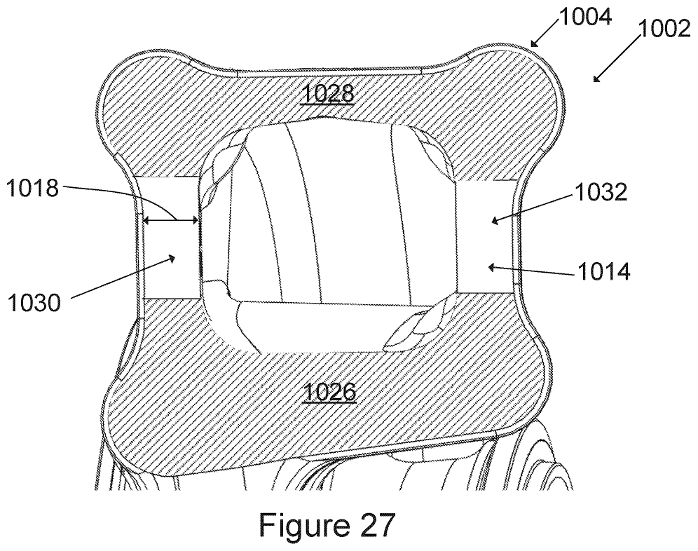

FIG. 27 is a further close-up view of the flange 1004 with two further surface areas 1026, 1028 indicated thereon. The surface areas 1026, 1028 correspond to entire regions of the first portion and second portion 1026, 1028 respectively. The surface area of the first portion 1026 of the periphery is greater than the surface area of the second portion 1028 of the periphery.

It will be appreciated that any of the flanges described or illustrated in this document may be inclined, or rotated, as described and illustrated in connection with FIG. 22. The molten metal material used to manufacture the turbine housing may be Spheroidal Graphite iron. Stainless steel may otherwise be used to manufacture the turbine housing.

The volute of the turbine housing may be free of feeder pads and/or reservoirs of material (e.g. feeders). The turbine housing in accordance with the disclosure may be described as flange-fed.

The described and illustrated embodiments are to be considered as illustrative and not restrictive in character, it being understood that only preferred embodiments have been shown and described and that all changes and modifications that come within the scope of the disclosure as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the disclosure set out herein are also applicable to any other aspects of the disclosure, where appropriate.

1. A turbine housing for a turbocharger, the turbine housing comprising:
a flange, the flange having an engagement surface and a first inlet opening in the engagement surface; and
a volute which extends around an axis and defines at least part of a flow passage through the turbine housing, the flow passage extending from the first inlet opening at a first end of the flow passage;
wherein the engagement surface of the flange is defined by a periphery of material which extends around the first inlet opening between the first inlet opening and an outer edge of the engagement surface;
wherein a thickness of a first portion of the periphery, at a radially inner side of the first inlet opening, is greater than a thickness of a second portion of the periphery, at a radially outer side of the first inlet opening, along at least a full extent of a radially inner edge of the first inlet opening.

2. The turbine housing according to claim 1, wherein the full extent of the radially inner edge of the first inlet opening is a full axial extent of the radially inner edge of the first inlet opening.

3. The turbine housing according to claim 1, wherein the thickness of the first portion of the periphery is greater than the thickness of the second portion of the periphery along at least a full extent of the first inlet opening.

4. The turbine housing according to claim 3, wherein the thickness of the first portion of the periphery is greater than the thickness of the second portion of the periphery along a full extent of a radially inner edge of the outer edge of the engagement surface.

5. The turbine housing according to claim 1, wherein the radially inner edge of the first inlet opening comprises one or more linear portions.

6. The turbine housing according to claim 5, wherein the radially inner edge of the first inlet opening is linear.

7. The turbine housing according to claim 5, wherein the radially inner edge of the first inlet opening is at least partly arcuate.

8. The turbine housing according to claim 7, wherein the radially inner edge of the first inlet opening is arcuate.

9. The turbine housing according to claim 1, wherein the volute defines an outer volute surface, and wherein a surface extends between at least part of a radially inner edge of the outer edge of the engagement surface and the outer volute surface.

10. The turbine housing according to claim 9, wherein the surface comprises a fillet having a radius of at least around 10 mm.

11. The turbine housing according to claim 10, wherein the surface comprises a fillet having a radius of around 15 mm.

12. The turbine housing according to claim 10, wherein the fillet is defined in an entirely arcuate surface.

13. The turbine housing according to claim 1, wherein the turbine housing further comprises an outlet opening defined in an outlet portion.

14. The turbine housing according to claim 1, wherein the turbine housing is a thin-walled turbine housing.

15. The turbine housing according to claim 1, wherein the engagement surface comprises a plurality of bores.

16. The turbine housing according to claim 1, wherein the flange further defines a second inlet opening in the engagement surface of the flange; wherein the engagement surface is defined by a periphery of material which extends around the first and second inlet openings between the first and second inlet openings and the outer edge of the engagement surface; and
wherein the first portion of the periphery is disposed at a radially inner side of the first and second inlet openings, and the second portion of the periphery is disposed at a radially outer side of the first and second inlet openings.

17. The turbine housing according to claim 16, wherein the thickness of the first portion of the periphery is greater than the thickness of the second portion of the periphery along at least a full extent of a radially inner edge of each of the first and second inlet openings.

18. The turbine housing according to claim 17 when dependent, directly or indirectly, upon claim 3, wherein the thickness of the first portion of the periphery is greater than the thickness of the second portion of the periphery along at least a full extent of each of the first and second inlet openings.

19. The turbine housing according to claim 18 when dependent, directly or indirectly, upon claim 4, wherein the thickness of the first portion of the periphery is greater than the thickness of the second portion of the periphery along a full extent of the radially inner edge of the outer edge of the engagement surface.

20. The turbine housing according to claim 1, wherein the thickness of the first portion of the periphery varies along at least the full extent of the radially inner edge of the first inlet opening.

21. The turbine housing according to claim 20, wherein the thickness of the first portion of the periphery decreases in a direction moving from an axially rear side of the first inlet opening towards an axially front side of the first inlet opening.

22. A turbine comprising:
the turbine housing according to claim 1; and
a turbine wheel, the turbine wheel being received by the turbine housing.
The turbine may be a fixed geometry turbine. The geometry may be a variable geometry turbine. The turbine may comprise a wastegate.

23. A turbocharger comprising:
the turbine according to claim 22;
a bearing housing configured to support a shaft for rotation about the axis; and
a compressor, the compressor comprising a compressor housing and a compressor wheel;
wherein the turbine wheel and compressor wheel are in power communication.

24. A turbine housing for a turbocharger, the housing comprising:
a flange, the flange having an engagement surface and a first inlet opening in the engagement surface; and
a volute which extends around an axis and defines at least part of a flow passage through the turbomachine housing, the flow passage extending from the first inlet opening at a first end of the flow passage;
wherein the engagement surface of the flange is defined by a periphery of material which extends around the first inlet opening between the first inlet opening and an outer edge of the engagement surface, the periphery comprising a pair of opposing axially disposed sides, and a pair of opposing radially disposed sides which extend between the pair of axially disposed sides;
wherein a thickness of a first of the pair of axially disposed sides, at a radially inner side of the first inlet opening, is greater than a thickness of a second of the pair of axially disposed sides, at a radially outer side of the first inlet opening, along an entire length of a radially inner side of the first inlet opening.

25. A turbine housing for a turbocharger, the housing comprising:
a flange, the flange having an engagement surface and a first inlet opening in the engagement surface; and
a volute which extends around an axis and defines at least part of a flow passage through the turbomachine housing, the flow passage extending from the first inlet opening at a first end of the flow passage;
wherein the engagement surface of the flange is defined by a periphery of material which extends around the first inlet opening between the first inlet opening and an outer edge of the engagement surface, the periphery comprising a pair of opposing axially disposed sides, and a pair of opposing radially disposed sides which extend between the pair of axially disposed sides;
wherein a first of the pair of axially disposed sides, at a radially inner side of the first inlet opening, has a greater surface area than a second of the pair of axially disposed sides, at a radially outer side of the first inlet opening.
